(19) United States
(12) Patent Application Publication
(10) Pub. No.: US 2013/0097558 A1
(43) Pub. Date: Apr. 18, 2013

(54) ADAPTIVE ARTISTRY

(71) Applicant: Matthew A. Lichtenstein, Cos Cob, CT (US)

(72) Inventor: Matthew A. Lichtenstein, Cos Cob, CT (US)

(73) Assignee: ADAPTIVE ARTISTRY, LLC

(21) Appl. No.: 13/273,718

(22) Filed: Oct. 14, 2011

(51) Int. Cl. G06F 3/048

(52) U.S. Cl. 715/810

(57) ABSTRACT

Aspects of the disclosure relate to generation, distribution and play back of adaptive artistry projects. An adaptive artistry project may include one or more adaptive artistry works. Each adaptive artistry work may include a plurality of specific adaptations or iterations created by an artist to be played under specific conditions. Thus, an end user's media experience for a particular work may be modified based on the status of conditions such as the time of day, the weather, the ambient lighting, the user's mood, or other environmental conditions. The status of the conditions may be obtained from local or remote sources. Adaptive artistry works may also be compiled into adaptive playlists that may themselves be dynamically modified based on the conditions.

### CROSS-REFERENCE TO RELATED APPLICATIONS

The present application is related to co-pending U.S. patent application Ser. No. 13/273,701, entitled “Adaptive Artistry,” attorney docket no. 3.0-001 I filed concurrently herewith, the disclosure of which is hereby incorporated herein by reference.

### BACKGROUND

In the case of a traditional music delivery, an artist records a song and mixes all the various components of the recording into a single stereo “master” audio file. In the case of a traditional film or video project, the filmmakers consolidate the final “cut” of the picture with all its audio elements synchronized into a single, linear video file. Thus, traditional singular music and video works provide users with the same experience each time the work is performed.

### SUMMARY

Aspects of the disclosure relate to generation, distribution and play back of adaptive artistry projects. An adaptive artistry project may include one or more adaptive artistry works. Each adaptive artistry work may include, for instance, a plurality of specific adaptations or iterations created by a user, hereinafter identified as an artist, to be played under specific conditions. The conditions selected by the artist may be referred to as influences. These influences may be used to select a particular iteration of the work for play back and/or presentation to an end user. An end user's media experience for a project or a particular work within the project may be modified based on the status of conditions such as the time of day, the weather, the ambient lighting, other environmental conditions, the user's mood, etc. The status of the conditions may be obtained from the user or from various local or remote sources. Adaptive artistry works may also be compiled into adaptive playlists that may themselves be dynamically modified based on the conditions.

One aspect of the disclosure provides a method of playing one or more works of an adaptive artistry project. The method includes accessing a set of variables defining possible conditions under which one or more works of the adaptive artistry project will play and accessing a plurality of media assets for playing the one or more works of the adaptive artistry project. For each variable of the set of variables, a processor identifies a current condition. The current condition for a given one of the variables is identified by transmitting a request to a server computer and receiving condition data for the given one of the variables therefrom. A set of media assets is selected from the plurality of media assets based on the identified condition associated with each respective variable. The one or more works of the adaptive artistry project is played based on the selected set of media assets.

In one example, the method also includes accessing a set of playlist preferences for a given one of the one or more works of the adaptive artistry project, the set of playlist preferences identifying combinations of possible conditions of the set of variables under which the given work will play, and selecting the set of media assets from the plurality of media assets is further based on the set of playlist preferences. In another example, the current condition for another given one of the variables is identified by requesting an end user to provide the at least one current condition, and the method further comprises receiving input, at a user input of the client device, identifying the at least one current condition. In another example, the current condition for another given one of the variables is identified based on information received from a sensor of the client device. In another example, the method also includes, during the playing of the one or more works of the adaptive artistry project, determining a new current condition for the another given one of the variables based on information received from a sensor of the client device; selecting a second set of media assets from the plurality of media assets based on the new current condition; and playing an updated work of the adaptive artistry project based on the second set of media assets after the playing of the one or more works of the adaptive artistry project has completed. In another example, the current condition for another given one of the variables is identified from information stored in local memory of the client device identifying a set of conditions under which at least a portion of the one or more works of the adaptive artistry project were previously played by the client device. In another example, the one or more works of the adaptive artistry project include a first work and a second work, and the method also includes accessing a set of playlist instructions for the adaptive artistry project, the playlist instructions identifying in what order the first work and the second work will play, and playing the first work and the second work is based on the set of playlist instructions for the adaptive artistry project. In another example, the method also includes during the playing of the one or more works of the adaptive artistry project, determining a new current condition for the given one of the variables by transmitting a second request to the server computer and receiving updated condition data therefrom; selecting a second set of media assets from the plurality of media assets based on the new current condition; and playing an updated work of the adaptive artistry project based on the second set of media assets after the playing of the one or more works of the adaptive artistry project has completed. In another example, the method also includes determining the current condition for the given one of the variables by comparing the received condition data to a lookup table stored locally at the client device.

Another aspect of the disclosure provides a system for playing one or more works of an adaptive artistry project. The system includes memory storing a set of variables defining possible conditions under which one or more works of the adaptive artistry project will play. The memory also stores a plurality of media assets for playing the one or more works of the adaptive artistry project. The memory is coupled to a processor. The processor is configured to for each variable of the set of variables, identify a current condition, the current condition for a given one of the variables is identified by transmitting a request to a server computer and receiving the current condition for the given one of the variables therefrom; select a set of media assets from the plurality of media assets based on the identified condition associated with each respective variable; and play the one or more works of the adaptive artistry project based on the selected set of media assets.

In one example, the processor is also configured to access a set of playlist preferences for a given one of the one or more works of the project, the set of playlist preferences identifying combinations of possible conditions of the set of variables under which the given work will play, and selecting the set of media assets from the plurality of media assets is further based on the set of playlist preferences. In another example, the system also includes a user input device coupled to the processor and the processor also configured to identify the current condition for another given one of the variables by requesting an end user to provide the at least one current condition; and receive input, at the user input of, identifying the at least one current condition. In one example, the system also includes a sensor device coupled to the processor and the processor is also configured to identify the current condition for another given one of the variables based on information received from the sensor device.

The system of claim 10, wherein the memory further stores information identifying a set of conditions under which at least a portion of the one or more works of the adaptive artistry project were previously played by the client device, and wherein the processor is further configured to identify at least one of the current conditions from the stored information. In another example, the one or more works of the adaptive artistry project include a first work and a second work, wherein the memory further stores a set of playlist instructions for the adaptive artistry project, the playlist instructions identifying in what order the first work and the second work will play, and the processor is also configured to play the first work and the second work based on the set of playlist instructions for the adaptive artistry project. In another example, the processor is also configured to, during the playing of the one or more works of the adaptive artistry project, update the current condition for the given one of the variables condition by transmitting a second request to a server computer and receiving an updated current condition; select a second set of media assets from the plurality of media assets based on the updated current condition; and play an updated work of the adaptive artistry project based on the second set of media assets after the playing of the one or more works of the adaptive artistry project has completed.

A further aspect of the disclosure provides a tangible computer-readable storage medium storing a set of variables defining possible conditions under which one or more works of the adaptive artistry project will play. The medium also stores a plurality of media assets for playing the one or more works of the adaptive artistry project. The medium further stores computer readable instructions of a program, the instructions, when executed by a processor, cause the processor to perform a method, including: for each variable of the set of variables, identifying, by a processor of a client device, a current condition, wherein the current condition for a given one of the variables is identified by transmitting a request to a server computer and receiving the current condition for the given one of the variables therefrom; selecting a set of media assets from the plurality of media assets based on the identified condition associated with each respective variable; and playing the one or more works of the adaptive artistry project based on the selected set of media assets.

In one example, the medium also stores a set of playlist preferences for a given one of the one or more works of the project, the set of playlist preferences identifying combinations of possible conditions of the set of variables under which the given work will play, and wherein the method further comprises selecting the set of media assets from the plurality of media assets is further based on the set of playlist preferences. In another example, the one or more works of the adaptive artistry project include a first work and a second work, the medium further stores a set of playlist instructions for the adaptive artistry project, the playlist instructions identifying in what order the first work and the second work will play, and the method further includes playing the first work and the second work is based on the set of playlist instructions for the adaptive artistry project.

### BRIEF DESCRIPTION OF THE DRAWINGS

FIG. 1A is a pictorial diagram of a system in accordance with an exemplary embodiment.

FIG. 1B-1C are functional diagrams of a system in accordance with an exemplary embodiment.

FIG. 2 is an example screen shot in accordance with an embodiment.

FIGS. 3A-3D are example screen shots in accordance with embodiments.

FIG. 4 is another example screen shot in accordance with an embodiment.

FIGS. 5A-5E are further example screen shots in accordance with an embodiment.

FIGS. 6A-6B are still other example screen shots in accordance with an embodiment.

FIGS. 7A and 7B are an example flow diagram in accordance with an embodiment.

FIG. 8 is another example flow diagram in accordance with an embodiment.

### DETAILED DESCRIPTION

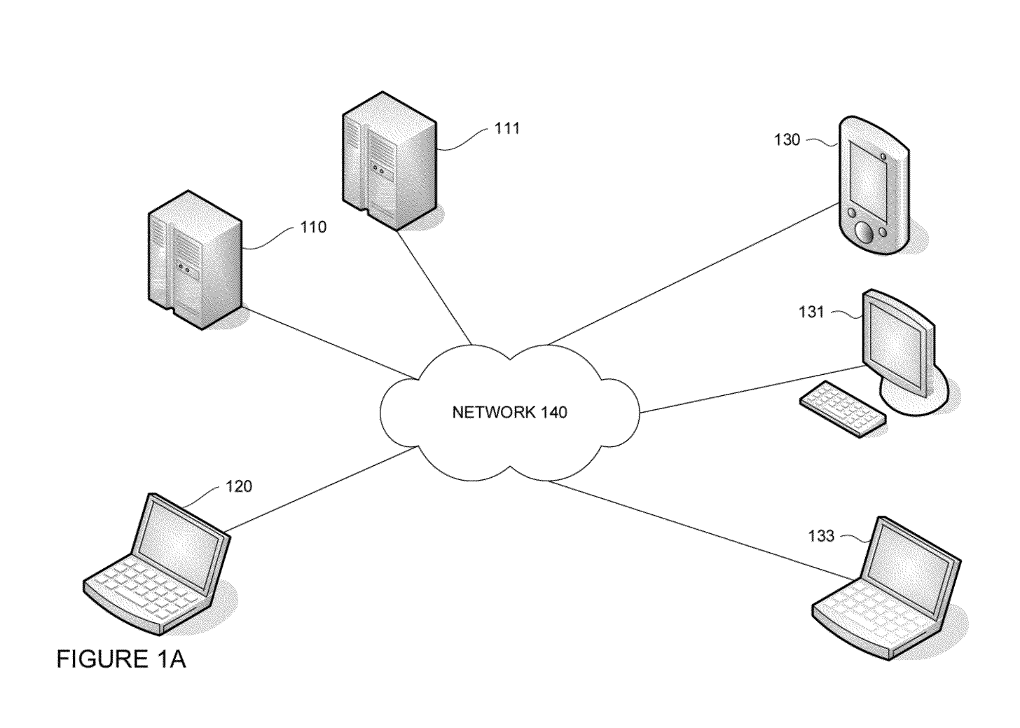

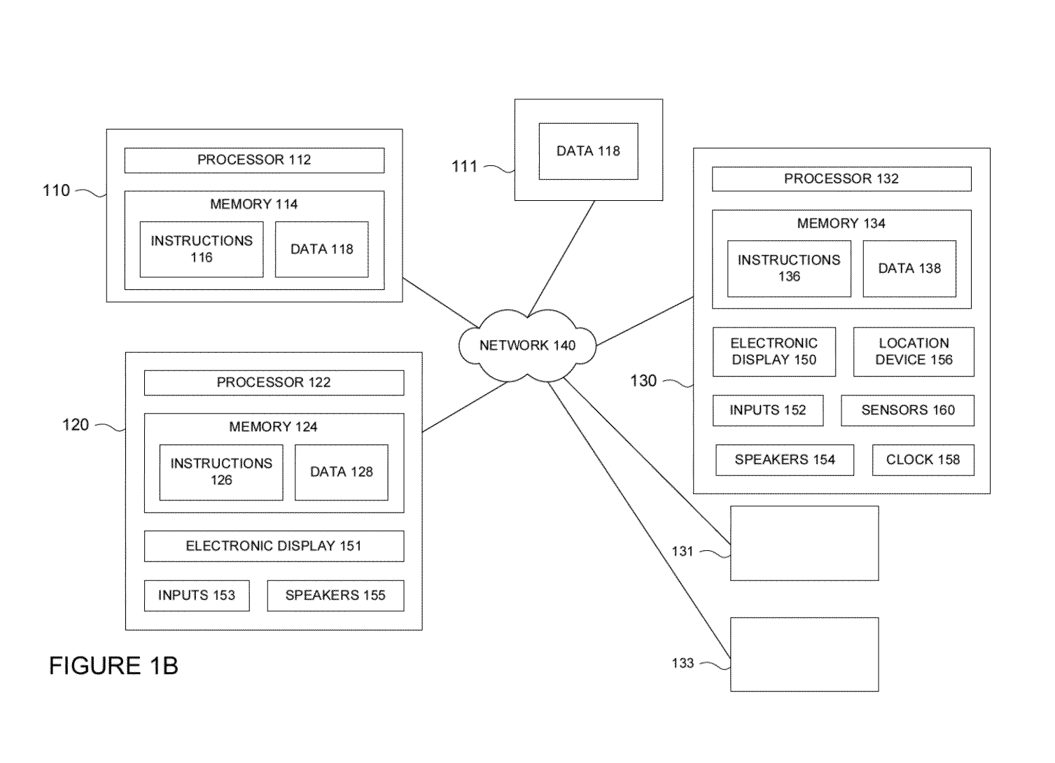

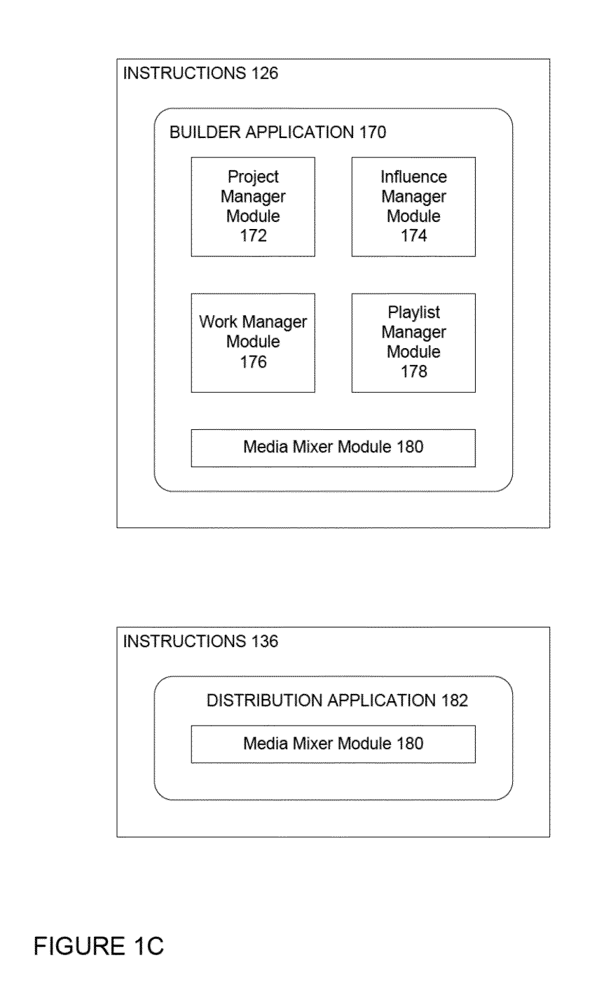

FIGS. 1A-1B depict a system 100 that may be used, among other functions, to generate, share, and play back adaptive artistry works. The system 100 may include server computers 110, 111, a first client computer 120, and a plurality of second client computers 130, 131, 133. These computers may send and receive information among one another via a network 140. For example, a user may generate an adaptive artistry project at the first client device 120. The adaptive artistry project may then be uploaded to the server 110 and distributed via the network to the second client computers 130, 131, 133 for play back to an end user. As described in more detail below, the server 110 may also provide the client computers with various information in order to assist in the play back of an adaptive artistry project.

The network 140, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems (e.g., dial-up, cable or fiber optic) and wireless interfaces. Although only a few computers are depicted in FIGS. 1A-1B, a typical system may include a large number of connected computers, with each different computer being at a different node of the network 140.

Each of computers 110, 111, 120, and 130, 131, 133 may include a processor and memory. For example, as shown in FIG. 1B, server 110 may include memory 114 which stores information accessible by a processor 112, computer 120 may include memory 124 which stores information accessible by a processor 122, and computer 130 may include memory 134 which stores information accessible by a processor 132.

The processors 112, 122, 132 may be any conventional processor, such as commercially available CPUs. Alternatively, the processors may be dedicated controllers such as an ASIC, FPGA, or other hard-ware-based processor. Although shown in FIG. 1B as being within the same block, the processor and memory may actually comprise multiple processors and memories that may or may not be stored within the same physical housing. For example, memories may include be a hard drive or other storage media located in a server farm of a network data center. Accordingly, references to a processor, memory, or computer will be understood to include references to a collection of processors, memories, or computers that may or may not operate in parallel.

The memories may store applications or instructions 116, 126, 136 that may be executed by the respective processor. The memories also includes a second part storing data 118, 128, 138 that may be retrieved, stored or modified in accordance with the respective instructions. The memory may include any type capable of storing information accessible by the processor, such as a hard-drive, memory card, ROM, RAM, DVD, CD-ROM, write-capable, and read-only memories or various combinations of the foregoing where the applications 116 and data 118 are stored on the same or different types of media.

The instructions 116, 126, 136 may be any set of instructions to be executed directly (such as machine code) or indirectly (such as scripts) by the processor. In that regard, the terms “applications,” “instructions,” “steps” and “programs” may be used interchangeably herein. For example, the instructions 116 of the server 110 may include influence applications for collecting and collating real-time data required by various processes as well as distributing data to the client devices, tracking user statistics and social interaction features, and providing content updates.

As shown in FIG. 1C, instructions 126 of the first client device may include a builder application 170 used by an artist for creating adaptive artistry works and projects. The builder application may include a plurality of software modules, including for example, a project manager module 172, an influence manager module 174, a work manager module 176, a playlist manager module 178, and a media mixer module 180. Each of the modules may be associated with a user interface for displaying on a client device in order to assist the user to utilize the functions of the particular module.

The project management module 172 may function as a control center during the creation of a project, allowing for the structural management of all components of the work, including the assets and metadata (such as a project's name, credits, legal information, etc.), as well as the management of playlists of adaptive artistry works. The project management module may also package a completed work, for instance by compiling all of the assets of a work into a single album file suitable for distribution and play back via a distribution application described in more detail below.

The influence manager module 174 facilitates the selection of influences for a project by the artist. The influence manager may also allow the artist to customize the influences as described in more detail below.

The work manager module 176 facilitates the organization, programming and testing of all the iterations for a work using a work manager interface.

The playlist manager module 178 facilitates the creation of playlists of the works within an adaptive artistry project. The playlist manager module may allow the artist to define the relationships between the project's influences and the use and sequencing of the works under the particular conditions of the influences as describes in more detail below.

In one embodiment, the media mixer module 180 may provide the functionality of a simple non-linear editor, multitrack mixer and player for digital media content, and includes a selection of signal processing components (e.g. reverb processor, equalizers, color filters, etc). The media mixer module may assist the artist to populate the iterations by using a media mixer interface. The media mixer interface allows the artist to organize, layer, position, mix, and process the assets for each iteration as well as to test the play back of that Iteration.

Instructions 136 of server 110 may include distribution applications 182 for distributing, loading, and playing adaptive artistry projects to an end user. The media mixer module 180 may be included in both the builder application as well as the distribution application. In the distribution application 182, the media mixer module 180 may be a data processing module that need not display the user interface. The media mixer module may function to load and play back the iterations of a particular work and may or may not include a displayed user interface. In some examples, the artist may be able to enable a displayed user interface that allows an end user to modify an iteration or create his or her own iterations of some or all of the works in an adaptive artistry project.

The data 118, 128, 138 need not limited by any particular data structure. For example, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data.

The data 128 of the first client device may include information used by the builder applications to create adaptive artistry works. For example, the data 128 may include various assets. In one aspect, the assets may include all of the media files and data files related to adaptive artistry works. An asset may refer to an individual file or a set of files strung together and used by the artist as a single unit. Some assets, referred to as medial assets, may include a variety of streaming audio, streaming video, and still-image file formats (e.g. Quicktime video, WAV audio, JPEG, PNG, etc.). For example, the still-image files may be referred to as artwork for an adaptive artistry work.

The media assets may be generated by the artist or preconfigured and simply used by the artist to arrange an adaptive artistry work. For example, an artist may generate an audio asset by mixing selected audio elements together into stereo stems using the media mixer display described below or some third party audio mixing tools. In another example, the assets may be preconfigured by another artist. The media assets may represent the building blocks or components of a mix, separately stored for the purposes of fixing the overall aesthetic qualities of a recording but allowing for some continued mix flexibility (e.g. allowing for a remix). During the play back of an adaptive artistry work, the assets that make up an iteration (including audio) may be processed and layered in different combinations, timeline positions, volumes, etc. to create all the various adaptations of a work.

An artist may also generate a video asset. For example the artist may edit, color-correct, and otherwise finish a video in sections or audio stems rather than creating one complete linear “cut.” This may allow for the fixing of the overall aesthetic qualities of the picture while maintaining some flexibility in the actual storytelling. Additionally, a film's audio elements may be treated similarly to a musical work. The dialogue, music and sound effects may all be mixed into independent audio stems. During play back of an adaptive artistry work, the video stems and audio stems that make up an iteration (including audio and video) may be processed and layered in different combinations, timeline positions and volumes to create all the various adaptations of the work.

Data 128 of the first client device may include a set of variables. The variables may be selected by an artist in order to dynamically modify an adaptive artistry project and the works of the project. The variables may be configured to employ current information about the user's environment such as the time of day (“Time”), day of the week, time of year (“Season”), sky conditions or weather (“Sky”), outdoor temperature (“Outdoor Temperature”), indoor temperature, relative humidity, the ambient lighting (“Light”), ambient noise (“Noise”), acceleration or movement, geographic location, etc. The variables may also be associated with information about the user's environment provided directly by the audience or end user (“Provided” or “Audience Provided”). Still other variables may include pre-defined internal triggers (“Trigger”) programmed by the artist. For example, a Trigger may be the number of times a consumer has played back a particular adaptive artistry work, or it could be a specific date.

Before play back of an adaptive artistry project or a particular work, the source for a variable's current condition may be “Local” (e.g. from the memory of the second client device playing the work), “Remote” (e.g. provided to the second device from server 110), or “Provided” (e.g. received by the second client device from an end user. For example, the Source for “Ambient Light” and “Time of Day” may be Local, the Source for “Sky,” “Weather,” and “Outdoor Temperature” may be remote, and the Source for “Provided” may be provided.

In one embodiment, the source for a variable's condition may be provided from two different types of sources. For example, a variable such as “Period of Day Conditions” may be associated with “daylight” and “nighttime” conditions. In order to determine the status of the variable, both “local” sources, such as a clock, as well as “remote” sources, such as a listing of local sunrise and sunset times, may be queried.

Variables selected by the artists for use in a particular adaptive artistry work may be referred to as “influences.” The selected influences may be associated with a set of pre-defined conditions. For example, each set of conditions for a particular variable may include a linear spectrum, cyclical progression, or either/or states. While the conditions may be pre-defined, the artist may also be permitted to create different names for the conditions which may or may not be provided or displayed to an end user. For example, an artist may choose to use the name “tick tock” rather than “Time” for the time condition, etc. Table 1 identifies the set of pre-defined conditions for a few of the example variables above.

TABLE 1
VARIABLES AND PRE-DEFINED CONDITIONS

| Variable | Set of Pre-Defined Conditions |
|---|---|
| Time | Morning \| Midday \| Evening \| Night |
| Season | Winter \| Spring \| Summer \| Autumn |
| Weather | Clear \| Partly Cloudy \| Overcast \| Precipitating |
| Temp | Cold \| Mild \| Hot |
| Light | Dim \| Bright |
| Noise | Quiet \| Loud |
| Provided | Condition1 \| Condition2 \| Condition3 \| Condition4 |

Table 1 above is merely one set of examples of variables and their respective conditions. For example, another variable “sky” may have two conditions, “Precipitating” and “Not Precipitating.”

In one embodiment, the use and names for the “Provided” variable's conditions may be defined by the artist. This may allow for a vast number of possibilities for programming and presenting an adaptive artistry work. For example, an artist may choose to use the provided influence to account for the end user's mood during the play back of an iteration of the work. In this example, the artist may name and define the provided conditions as “Sad”, “Mellow” and “Happy”. In another example, an artist may select to use a provided influence to account for the end user's listening preferences regarding the types of mixes of music. In this example, the artist may name and define the provided conditions as “With Vocal” and “Instrumental”.

In some examples, a variable's conditions may be defined by a minimum of two boundary points. The boundary points may quantify the specific range of data values that represent a particular condition. As described in more detail below, each condition may be associated with default boundaries that may be adjusted by the artist. For example, if the variable is “Time,” the default boundaries of the evening condition may be 1 hour before local sunset and 2 hours after local sunset while the default boundaries of the night condition may be 2 hours after local sunset and 1 hour before local sunrise. In another example, if the variable is the “Outside Temperature” the default boundaries of the cold condition may be −20 degrees Fahrenheit and 40 degrees Fahrenheit while the default boundaries of the mild condition may be 40 degrees Fahrenheit and 70 degrees Fahrenheit.

Some variables may be associated with conditions that are defined by only two states. For example, these two-state variables may be defined by a single value, such as yes or no, 0 or 1, etc. In such cases, only a single value may be active at a time. In one embodiment all of the conditions of the provided variable may be of the two-state type such that the end user may be asked to select only one current “active” condition from a list of possible conditions set by the artist.

In yet another example, some variables may be associated with conditions that are defined by boundaries points as well as two states. These “hybrid” variables may require the collection and assessment of two different types of data in order to determine the current condition for playback of a project. When playing back an adaptive artistry project with a hybrid variable assigned as in influence, the hybrid variable's two-state conditions may be considered first. If the current data matches the defined parameters of a two-state condition, then that condition may be used for play back. If the current data does not fit within the defined parameters of a two-state condition, the boundary-point conditions may be examined to determine the actual condition of the hybrid variable.

For example, the Sky variable may be a hybrid variable associated with the conditions set forth in Table 2 below.

TABLE 1
HYBRID SKY VARIABLE AND CONDITIONS

| Conditions | Constraints of the Conditions |
|---|---|
| Clear | Local-area weather forecast showing sky cover |
| | between 0% and 20% |
| Partly Cloudy | Local-area weather forecast showing sky cover |
| | between 20% and 60% |
| Overcast | Local-area weather forecast showing sky cover |
| | between 60% and 100% |
| Precipitation | Local-area weather forecast that indicates |
| | current (or imminent) precipitation |

The precipitation condition may be based upon precipitation data and may be defined as a two-state condition. The clear, partly cloudy, and overcast conditions may be based on sky cover data and may be defined by boundary states. If an adaptive artistry project is associated with the sky influence, the condition of the two-state precipitation condition may be evaluated first. If there is current (or imminent) precipitation, the sky influence may be identified as the precipitation condition. If the forecast indicates that there is no current (or imminent) precipitation, the other conditions may be evaluated.

The data 118 of the server 110 may include condition data for each of the Remote variables. For example, the sever 110 may access various databases of in order to provide the second client devices with information sufficient to identify a relevant condition for each variable. In this regard, the condition data may include weather reports and other information. In addition to the condition data, data 118 may also include user statistics and other administration information.

The data 128, 138 may also include completed adaptive artistry projects. For example, as noted above, the adaptive artistry projects may be initially stored in data 128 of a first client device and subsequently transmitted to a server for distribution. The server may then store the project in data 118. Upon request from a client device, such as for example, after a purchase of an adaptive artistry project, the server may transmit the project to a second client device for storage in data 138 in order to allow the second client device to play back the work to an end user.

In one example, server 110 may be a dedicated distribution server which distributes the adaptive artistry projects, works, and updates to the client devices. As noted above, server 110 may be a single server or multiple servers. The distribution server may also store and manage the iterations files and assets for a plurality of different projects. For example, a client device may request particular iteration files or assets from the distribution server as needed for preparation or play of a work in order to reduce the memory required to store assets at a client device when the assets are not needed. In this example, the server may also mix and process the iterations and transmit the resulting audio and imagery to the client device. If there is a dedicated distribution server, a second server, such as server 111 of FIGS. 1A and 1B, may store or maintain the condition data of data 118.

Other data such as user statistics, user data for various social interaction features described in more detail below, etc., may be stored or maintained either by server 110, server 111, or yet another server.

Each completed project may include a plurality of files to be used by the second client devices to play back iterations of the adaptive artistry works of the project. For example, the each adaptive artistry work may be associated with a work file, a plurality of iteration files, and a conditional relationship file. These files may be created, managed, and manipulated by the builder applications using various formats, including for example, Extensible Markup Language Format (XML).

A work file, may store metadata associated with a single adaptive artistry work such as credits, song lyrics, etc. The work file may also be used to maintain a database which tracks the file paths for all of the assets and iteration files for the particular work.

An iteration file may track the file paths for all of the assets used in a single iteration. The iteration file may also describe any play back qualities or attributes of the iteration. For example, an attribute file may include attribute flags determined and set by the artist during the creation of an adaptive artistry work. Each attribute flag may represent a category of an attribute and the setting selected by an artist or the default setting for the attribute.

An iteration file may therefore include various attribute categories, including but not limited to, media attributes, track attributes, and global attributes for a string of assets in a particular work iteration. The string of assets together with the various media and track attribute flags may be referred to as an event track. An iteration may include a set of one or more event tracks and the global attribute flags. Although the examples of attributes described herein are based on common features employed when producing musical or audiovisual works, various other attributes which account for more complicated digital signal processing and signal routing may also be used.

In the example above, media attributes may describe the timeline positions, editing decisions, and play back status of the assets within a particular event track. The media attributes may include features such as “Position” which may describe the position of each asset on a fixed linear timeline. For example, an artist may use an industry-standard SMPTE time code as a time base, or beats per minute at a specified tempo. Another media asset may include a “Clips” feature which may describe the creation, content and length of independent sub-regions or sections of a set of assets in an event track. A “status” feature may be used to describe an inactive or active state of an asset in an event track.

Another category of attributes may include track attributes such as the play back qualities, routing and status of an event track. The track attributes may include features such as “Volume”, which may describe the play back volume of an audio-based event track. A “Panning” feature may describe the position on a stereo spectrum (or surround-sound matrix) of an audio-based event track. A “Mute” feature may be used by the artist to change the active or inactive state of an event track. An “Effect Send” feature may describe the routing of an audio-based event track's content to a selected audio effect bus. An “Effect Type” feature may be used to manipulate various signal processing modules, such as reverb, echo, color filer, etc., inserted into the signal path of an individual event track. An “Effect Setting” feature may describe the qualities and settings assigned to a signal processing module in an effect-based event track.

Another example category of attributes may include global attributes that describe settings that will apply to a complete Iteration. For example, an artist may set features such as “FXBusType” feature that describes the kind of signal processing module assigned to an interation's FX send busses, such as reverb, echo, etc. An “FXBusSetting” feature may describe the qualities and setting assigned to a signal processing module that is active on an iteration's FX send bus. An “FXBusVolume” feature may describe the playback volume of processed audio from an FX send bus. A “MasterEQ” feature may describe any frequency manipulation that will be applied to the complete audio mix of an iteration just prior to playback. A “MasterLimiting” feature may describe any amplitude manipulation that will be applied to the complete audio mix of an iteration just prior to playback. A “MasterVolume” feature may describe the master play back volume of a particular Iteration. A “Speed” feature may be used to adjust the play back speed of the iteration. A “Pitch feature may be used to adjust the pitch transposition of all audio-based assets within the iteration.

An adaptive artistry work may also be associated with a conditional relationship file that may include a lookup table that links each possible set of influence conditions for the work to a specific iteration file used to construct and play back the iteration associated with the particular influence conditions.

A plurality of adaptive artistry works may also be compiled into adaptive artistry projects. Each project may be associated with the relevant work-specific files as well as a project or master file, an influence file, a playlist file, an artwork file, an adaptation file, and an album file.

The master file may track and organizes all of the assets of the work. The master file may also include metadata related to the complete work such as production credits, legal info, etc.

An influence file may store and organize a project's influence selections and settings, as described in more detail below. For example, the influence file may specify the variables that are to be requested and collected during playback of an adaptive artistry project. The influence file may contain a lookup table that details how the values of that collected data are to be used to assign a condition to each of the project's influences.

A playlist file may include a lookup table that links each possible set of a project's influence conditions to a specific set and playback sequence of selected adaptive artistry works within the project. The set and sequence of works may be referred to as a playlist sequence. The playlist file may also include a work catalog lookup table and a playlist sequence lookup table. The work catalog lookup table may include a list of all of the works associated with a project as well as the playlist preferences for each work of the project. The playlist sequence lookup table may link each possible set of a projects influence conditions to a specific set and sequence (playlist sequence) of works within a project.

An artwork file may track the file paths of any artwork associated with an adaptive artistry project and describe the layout and use of the artwork during play back of an iteration in the distribution application.

An adaptation file may document a unique sequence of works as well as the specific iteration files that are used to recreate a particular adaptation of an adaptive project. For example, an end user may select to save, or the artist may make available, a particular adaptation of an adaptive project associated with a particular set of conditions. The adaptation file may allow the end user to play the particular adaptation regardless of the current influence conditions. The adaptation files may be managed by an end user by way of an adaptation library interface of the distribution application. The adaptation library may enable the user to save favorite adaptations, load preset adaptations provided by the artist, and load and share particular adaptations with friends. This may also allow a user to access a preconfigured “best” or “radio version” of a particular adaptive artistry project selected by an artist.

Each adaptive artistry project may be associated with an album file. The album file may bundle all of the assets (audio, video, artwork, etc.) for the particular work into a distributable package or set of packages that may be loaded or imbedded into a distribution application for play back to the end user. In one example, the album file may also be embedded into an artist-branded distribution application such that the artist-branded distribution application would only be able to play a particular adaptive artistry project. In another example, distribution application may also include an adaptive album management module to allow for the downloading, for example from server 110, and play back of a plurality of different album files. The album file may be based on various formats, including for example, Material eXchange Format (MXF) or may be a simple container file.

In addition to a processor, memory and instructions, client computers 120, 130, 131, 133 may have all of the components used in connection with a personal computer. For example, the client computers may include an electronic display 150, 151 (e.g., a monitor having a screen, a touch-screen, a projector, a television, a computer printer or any other electrical device that is operable to display information), one or more user inputs 152, 153 (e.g., a mouse, keyboard, touch screen and/or microphone), speakers 154, 155, and all of the components used for connecting these elements to one another.

The first client device 120 and second client devices may include a full-sized personal computers or mobile devices such as tablets, netbooks, or laptops. The second client devices may also include personal digital assistants, mobile phones, and music players capable of wirelessly exchanging data with server 110 over network 140. The second client devices may also include a location determination device 156 (such as a GPS receiver or geolocation software), a clock 158, and various environmental sensors 160, such as thermometers, ambient light sensors, microphone, etc.

In addition to the operations described below and illustrated in the figures, various operations will now be described. It should also be understood that the following operations do not have to be performed in the precise order described below. Rather, various steps may be handled in a different order or simultaneously. Steps may also be omitted or added unless otherwise stated herein.

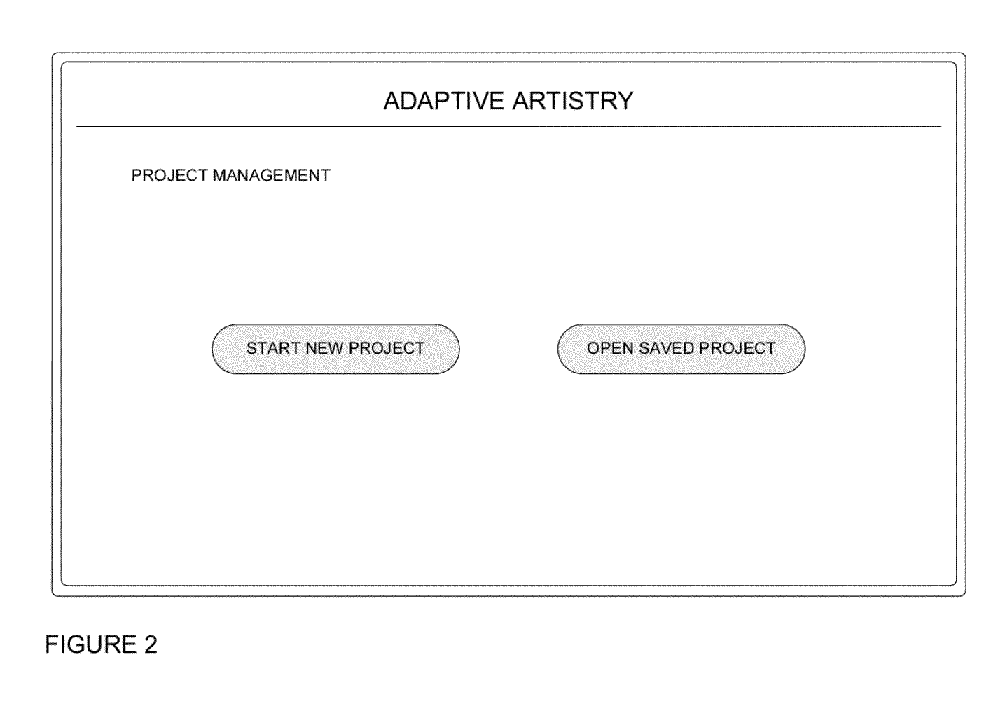

In order to create an adaptive artistry project, an artist may launch a builder application on a first computer. In response, the builder application may call a project management module. The builder application then displays a project management interface on the display of the artist's first computer. As shown in FIG. 2, from the project management interface, the artist may select between options to continue working on a saved project or begin a new project. If the artist selects to work on a new adaptive artistry project, the artist may provide a name. In response, the builder application may create a new project folder including a new project file, playlist file, and artwork file for the project. Once selected to be used in at least one iteration of a work of the project, the assets may also be stored within the project folder.

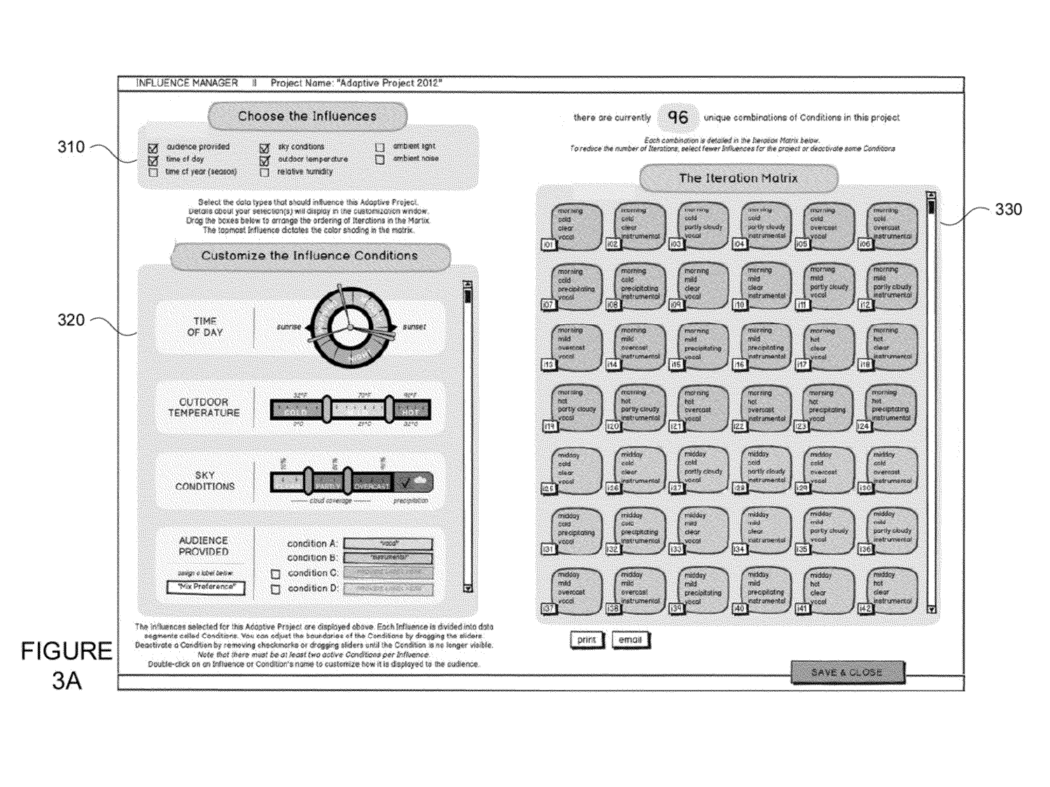

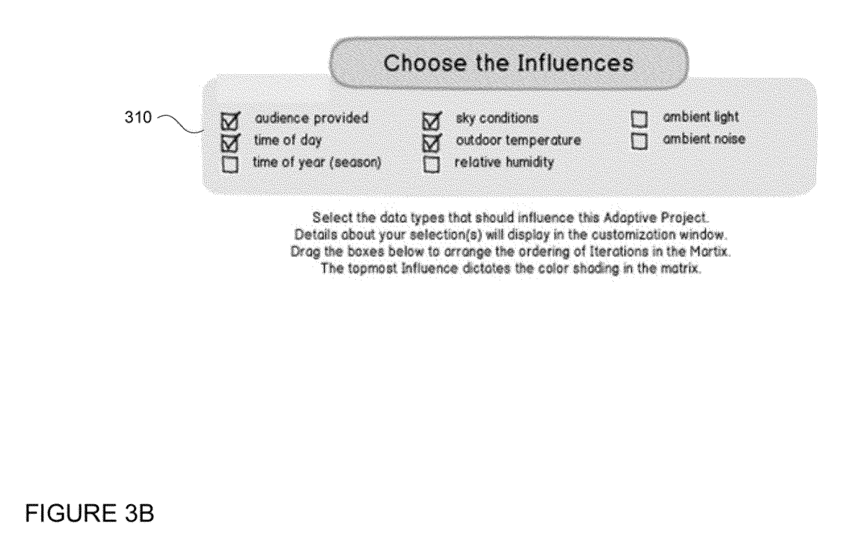

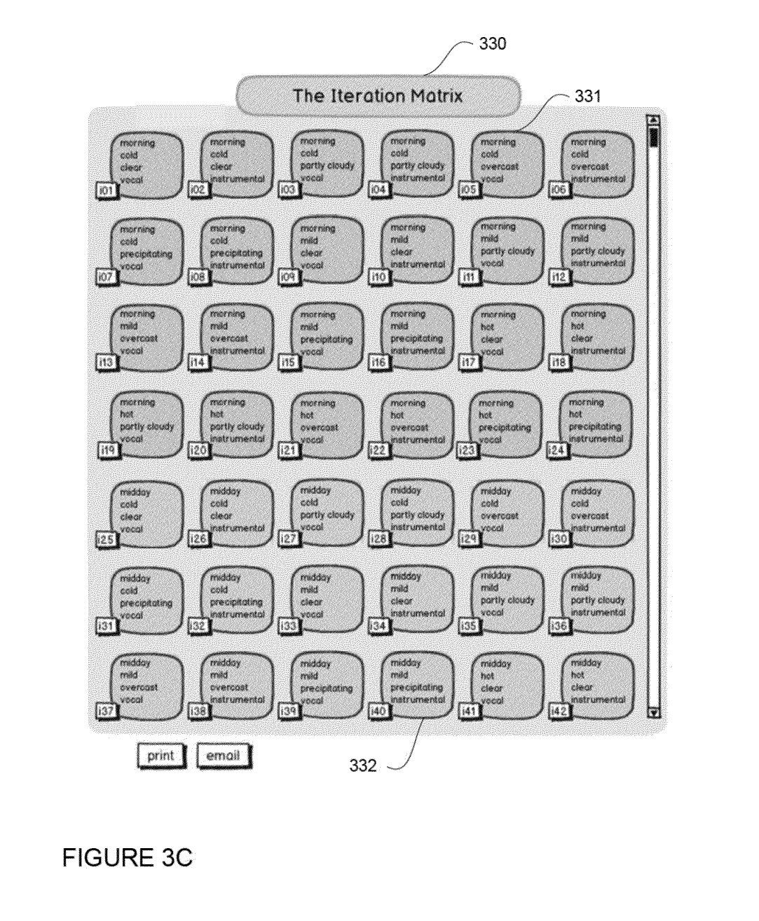

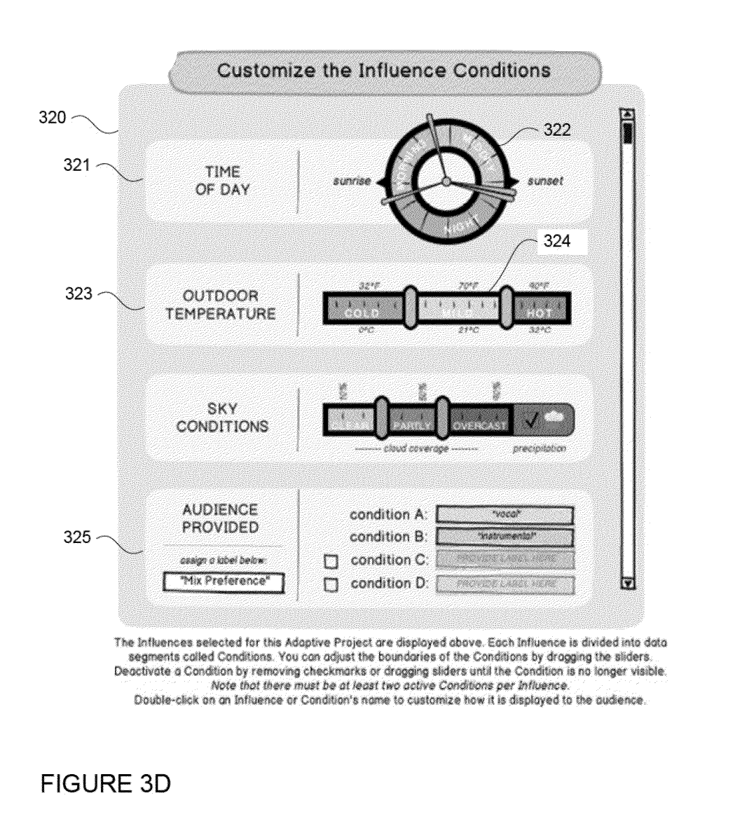

The builder application may then call an influence manager module which allows the user to select and manipulate the influences for the particular project. An example screen shot of an influence manager display is shown in FIG. 3A. The builder application also creates a new influence file for the project. As shown in greater detail in FIG. 3B, the builder application may allow a user to select a set of variables using for example box 310. This may allow the artist to select a plurality of variables to be used as active influences for the project. In the example of FIG. 3B, the artist has selected to use the “Audience provided,” “Time of Day,” “Outdoor Temperature,” and “Sky Conditions” variables as influences.

FIG. 3A also includes an iteration matrix 330. The matrix illustrates all of the iterations of the work that are possible based on the various combinations of the influences selected by the artist. The matrix may allow the artist to understand the relationships between the influence selections and the iterations. For example, as shown in more detail in FIG. 3C, the iteration matrix 330 may include an interactive graphical display that provides an artist with a visualization of the iterations and the relationships to the influences selected by the artist. The iteration matrix may utilize combinations of color coding, text labeling, and other visual indicators to illustrate an iteration's status and relationships to the artist.

As the artist selects the variables to be used as influences for the project, the iteration matrix 330 may be generated and displayed to the artist. The iteration matrix may be used by the builder application to demonstrate all of the various combinations for the conditions within the selected influences. For example, matrix 330 includes a plurality of icons 331, 332 or other representative image which represent iterations, each icon having an identifier (i01, i02, etc.) which may be used to identify the iteration. In this example, the iterations also identify their respective conditions, for example, in iteration i11, the conditions are midday time, mild temperature, and overcast sky.

The artist may also manipulate the boundaries of the conditions of the selected influences. For example, various user interfaces may be used such as the dynamically-adjustable visualizations of the boundary points. For example, as shown in detail in box 320 of FIG. 3D, if the artists selects the time of day variable, the artist may adjust the time of day settings 321. In this example, the influence manager interface may display a clock 322 with movable boundary points for each of the possible conditions, morning, midday, evening and night. In another example, the artist may select and adjust the outdoor temperature settings 323. The influence manager interface may display a temperature bar 324 with slidable boundary points for the cold, mild, hot conditions. In yet another example, if the artist has selected the “Audience Provided” variable, the artist may create the settings 325. The artist may provide the name of the influence, here “Mix Preferences,” as well as the conditions for the audience provided influence.

Any condition may be made inactive for a work by the builder application or the artist by assigning the condition with the same start and end boundaries points. In some examples, the artist may be required to identify at least two conditions active for each Influence selected for a Project. This will ensure that at least one work within a project will play under every possible set of conditions. For instance, a person living in Arizona would be displeased if the person purchased an adaptive artistry project that is programmed to only play when it was raining. However, certain individual works within a particular project may still be programmed not to play under certain conditions. Thus, the builder application may perform checks to ensure that at least one work will play for every set of conditions before allowing the project to be packaged.

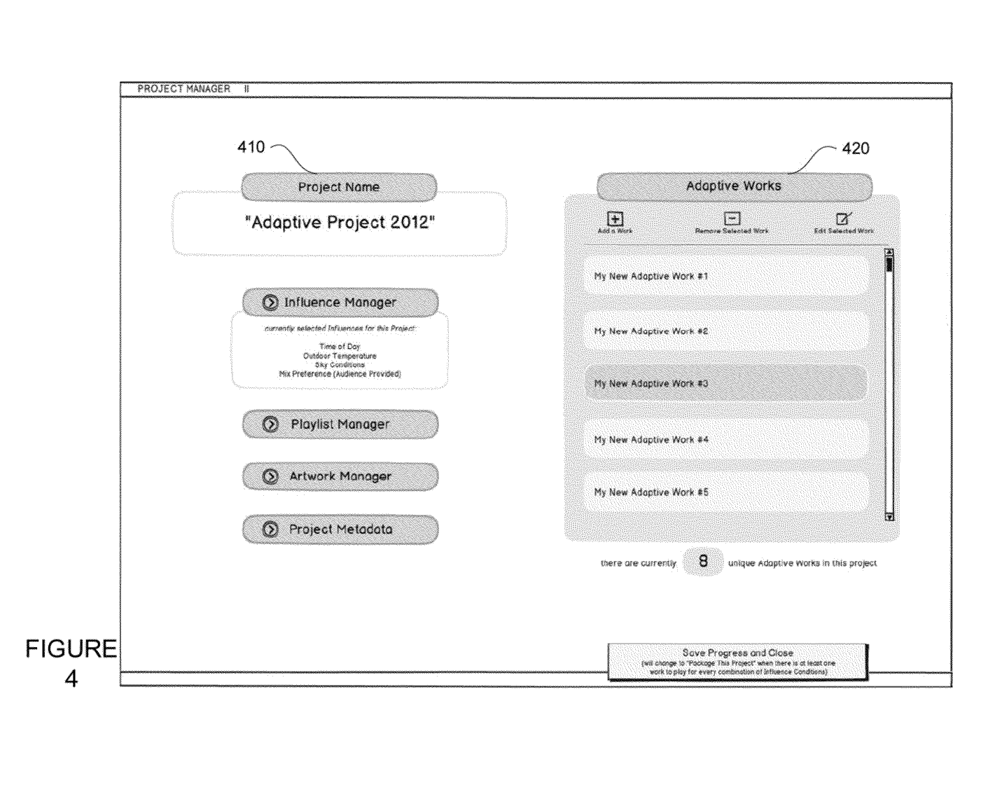

The builder application may allow the artist to use the same value that marks the end of one condition's Boundary to describe the start of the neighboring condition's Boundary, for example as shown in FIG. 3C. For example, the end of the evening time condition may be set 8:00 pm and the beginning of the night time condition may also be set at 8:00 pm. However, the distribution application may automatically give preference to the start boundary (or the end boundary) in order to prevent any overlap of the conditions. For example, if the time is 8:00 pm and the preference is for the start boundary, only iterations associated with the night time period could be played to the end user. Alternatively, if the time is 8:00 pm and the preference is for the end boundary, only iterations associated with the evening time period could be played to the end user. An iteration may only exist in one condition at any given time, thus, the default boundaries as well as the boundaries selected by the artist may not cause overlapping conditions. The final selected influences and boundary point settings may be saved to the project's influence file. The builder application may then return to the project manager display and allow the artist to create a new adaptive artistry work for the project. For example, as shown in FIG. 4, once a new project has been generated, the project manager display may identify a project name 410 and a list of works 420 for the project. The list 420 may allow the artist to add, remove, or edit works. When the artist selects to create a new work, the project manager module may then create and save a work file for the new work and adds details about the new work to the project's playlist file.

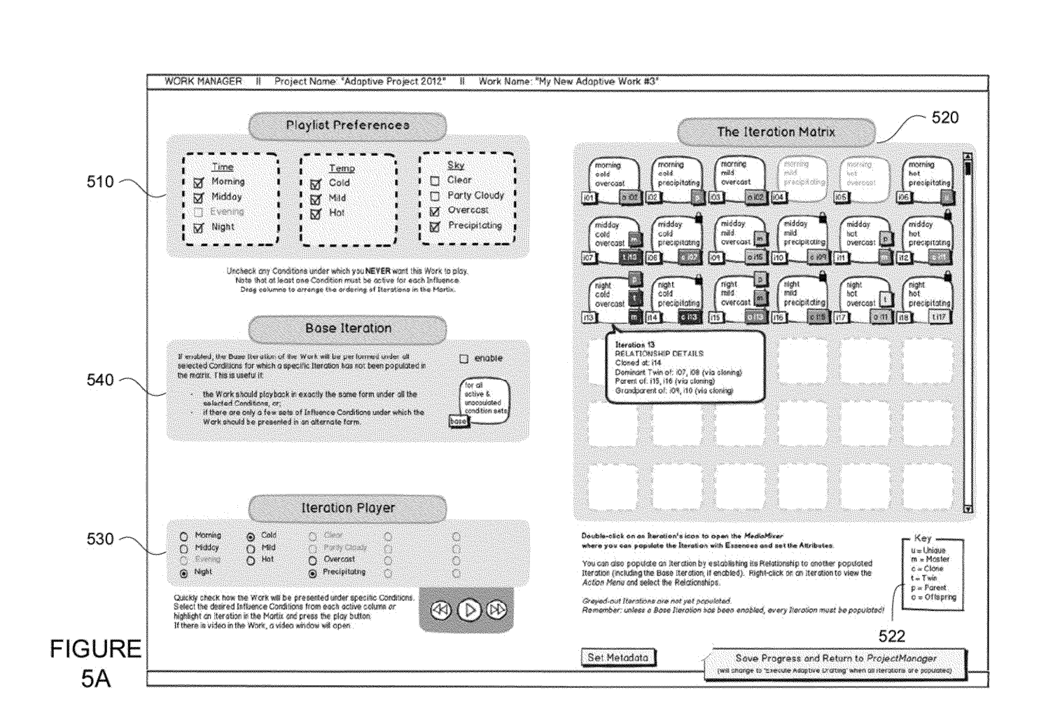

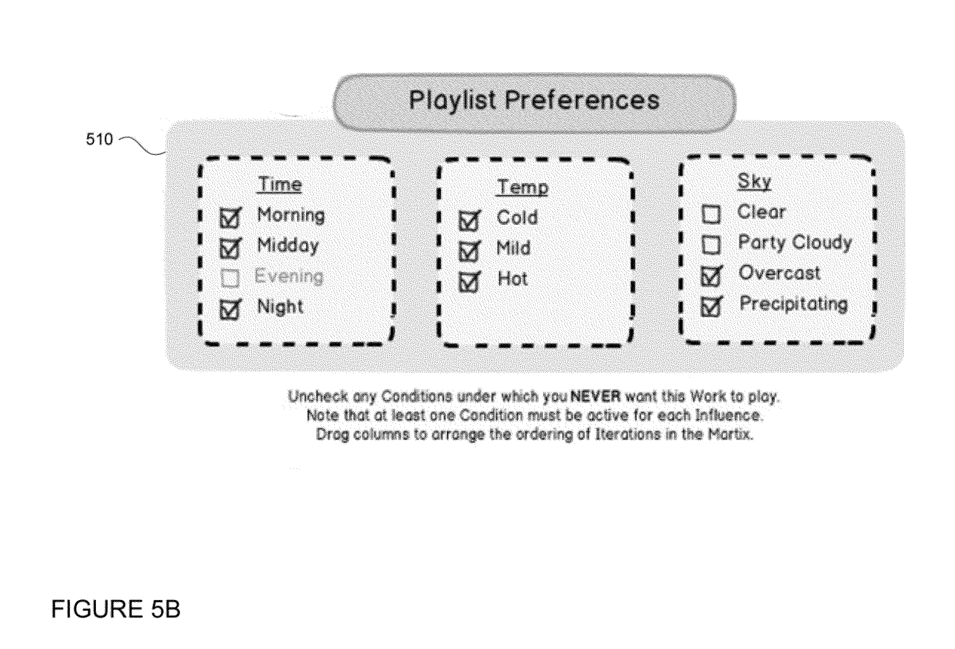

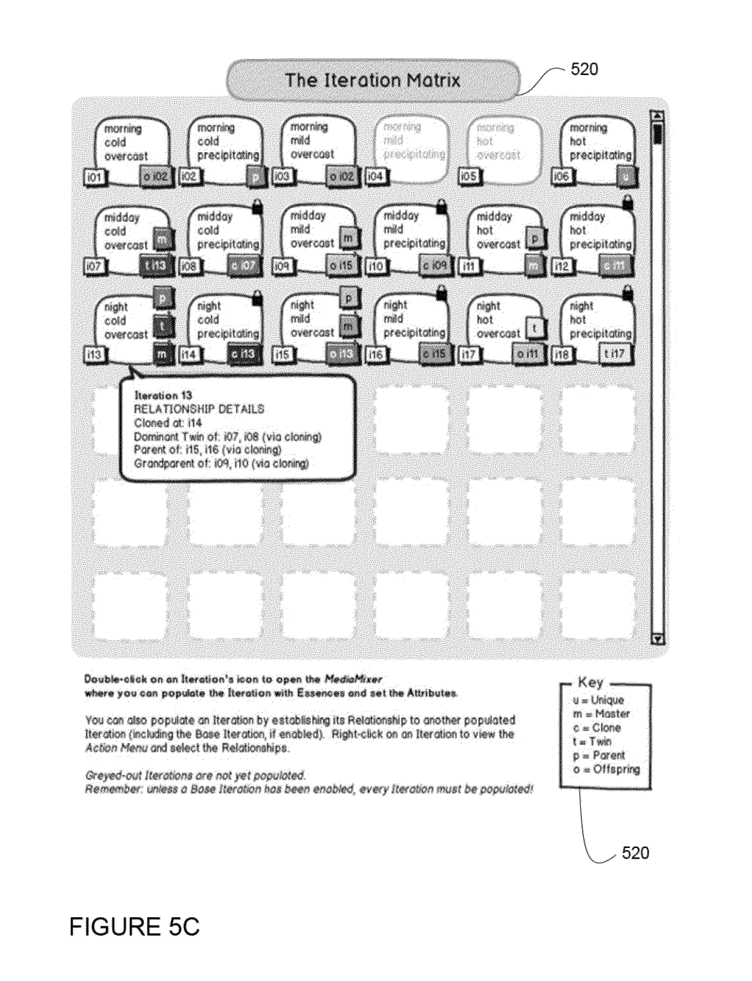

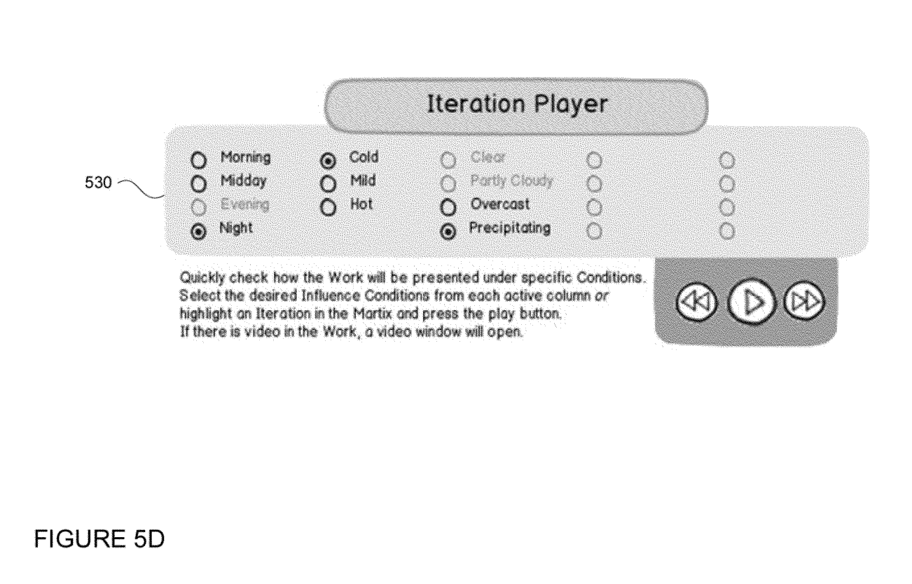

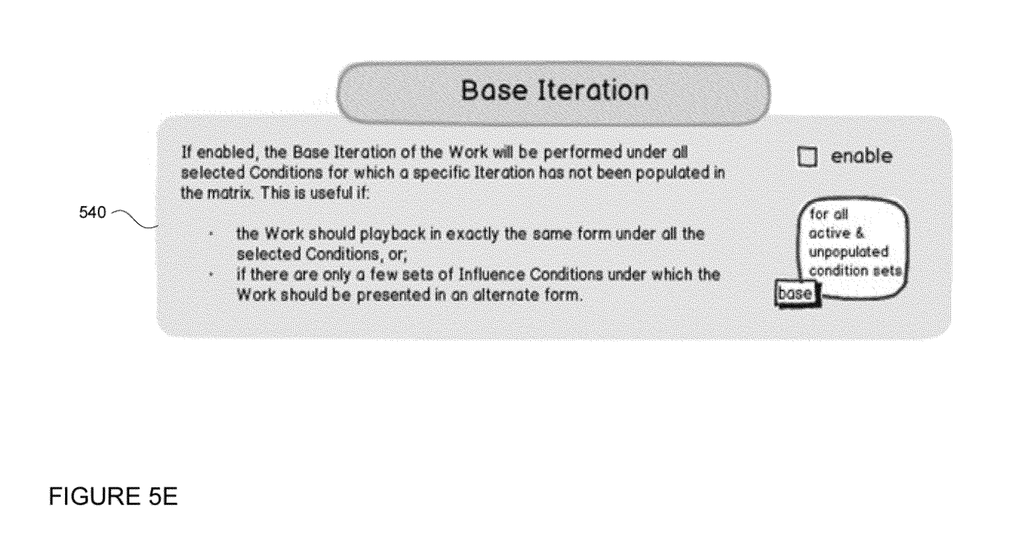

Once a work is selected for editing, the project manager may launch a work manager module depicted in FIGS. 5A-5E. For example, as shown in FIG. 5A, the work management interface may include a list of playlist preferences 510, shown in more detail in FIG. 5B, which allows the artist to select the conditions under which the work will play. In the example of FIGS. 5A and 5B, the artist has selected that the work will play during the overcast and precipitating conditions, but not during the clear or partly cloudy conditions. In another example, the playlist preferences may allow the artist to completely deselect a particular influence (and all of the influences conditions) for a particular work, thus reducing the number of iterations for the particular work and the number of iterations that the artist will need to populate. As the playlist preferences are selected and deselected, the iteration matrix may create or remove, darken or gray-out, or perform some other distinguishing change in order to identify the iterations that are active or inactive. For example, as shown in FIGS. 5A and 5C, iteration matrix 520 only includes icons representing active iterations. When the artist is satisfied with the selected playlist preferences, they may be saved to the playlist file.

Initially, the iterations may be unpopulated, that is, they would not include any event tracks or assets. Again, this may be reflected in the appearance of the iterations of the matrix. Returning to FIG. 5C, iteration i01 is shown as populated, in black outline, while iteration i05 is shown as inactive, grayed-out.

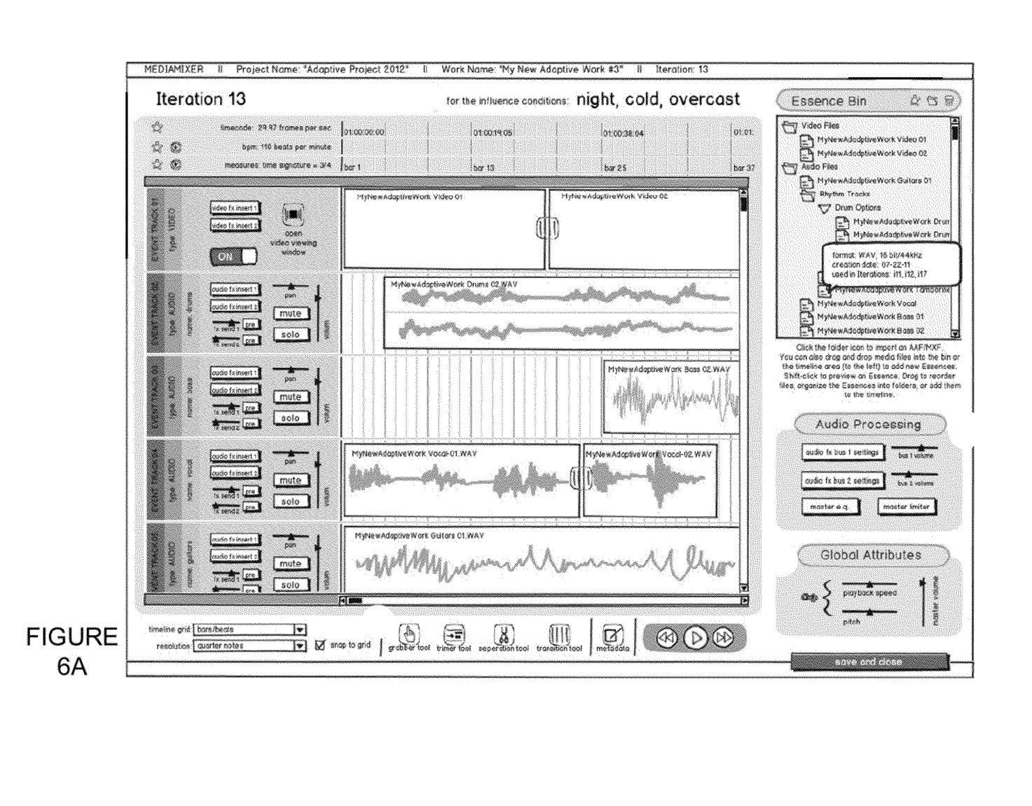

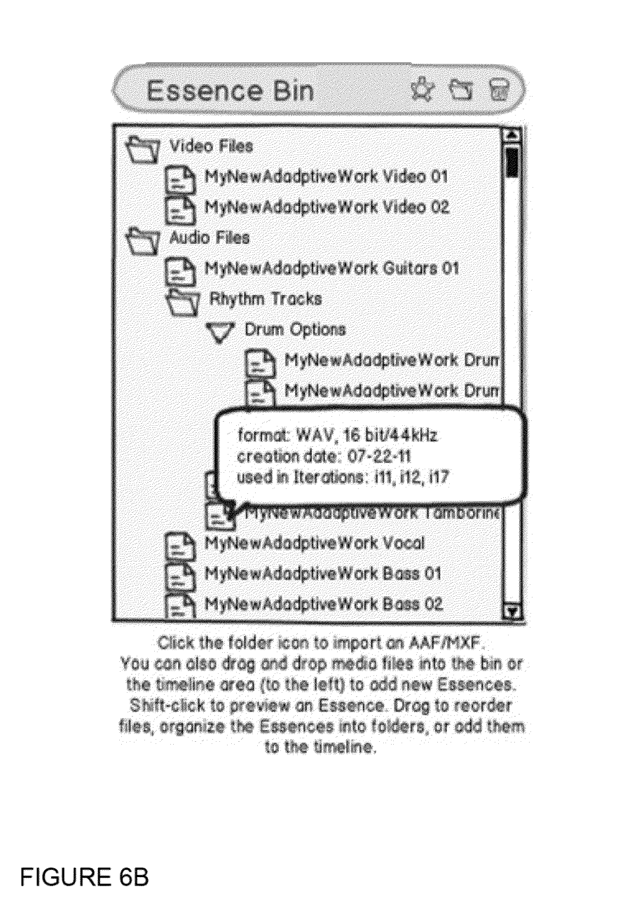

The artist may also select an iteration from the matrix, for example by tapping via a touch-screen display or clicking via a mouse or other input device. In response, the builder application may initiate a new iteration file for the selected iteration and call a media mixer module to populate the iteration. For example, FIG. 6A depicts an example screen shot for a media mixer display of iteration 13 (i13 of FIG. 5C).

An artist may add a set of event tracks to a selected iteration by accessing assets stored locally at the first computer or remotely at some networked location. The assets may either be pre-configured with the corresponding attributes as finished event tracks or selected and configured by the artist in order to create a new event track.

In one example, the artist may utilize an asset bin to access assets and generate finished event tracks. Asset bin 610 of FIGS. 6A and 6B may allow the artist to access asset files stored locally or remotely (at some network location). The artist may then click (using a mouse or touch screen) and drag the asset files, such as “MyNewAdaptiveWork Tambourine,” into the display in order to mix assets into event tracks as described below. The asset bin may also be used to update or replace assets with new versions as well as preview (play) individual assets. The asset bin may also allow the artist to track which assets are being used in which iterations. For example, as shown in FIG. 6B, “MyNewAdaptiveWork Tambourine” is currently being used in iterations i11, i12, and i17 of the current adaptive work.

To create a new event track, the artist may select a first asset. The selected asset may be positioned at the start of the event track along a timeline. Subsequent assets may also be added to the event track. Once the assets are selected, the artist may set the media attributes by moving the assets to desired positions on the timeline and making any trims, edits, or cuts to the assets. The artist may also set the track attributes. The artist may also play back a particular or plurality of event tracks in order to test the current attribute settings. If the artist is not satisfied with the particular event track which has been created by the artist (as opposed to pre-configured), the assets, media attributes, and track attributes may be adjusted.

Once the artist is satisfied with the event tracks selected for a particular iteration, the global setting for the iteration may be adjusted. Again, the artist may play back all or part of the iteration in order to test the current attribute settings for the iteration. If the artist is not satisfied with the iteration, the artist may continue to adjust the assets and attributes as discussed above.

Once satisfied with an iteration, the artist may enter any desired iteration-specific metadata. For example, the artist may enter a title, production credits, etc. This information as well as the event tracks and global settings may be stored in the selected iteration's iteration file and the iteration of the matrix is now populated. The artist then returns to the matrix to select additional iterations for population.

The work management interface may also include an iteration player 530, as shown in FIGS. 5A and 5D. The iteration player may allow the artist to quickly play various populated iterations by identifying the conditions. In other examples, the artist may also be able to play a particular iteration by providing the iteration's identifier.

If the artist has already created an iteration for this particular work, in addition to generating the new iterations as described above, the artist may also use a populated iteration as the basis of a related iteration. For example, the artist may select a populated iteration and call up an iteration action menu to begin populating an unpopulated iteration. For example, the iteration action menu may be a dropdown list on the work management interface (see FIG. 5A). In doing so, the builder application may duplicate the populated iteration's iteration file and associate the duplicated file with the unpopulated iteration.

The iteration action menu may allow the artist to perform certain actions on a selected iteration (populated or unpopulated). For example, the artist may clear an iteration (or wipe the event tracks and attributes of the iteration), import or export event tracks, copy a selected populated iteration to an unpopulated iteration, copy a selected populated iteration to all unpopulated iterations, “clone” a selected populated iteration to an unpopulated iteration, clone a selected unpopulated iteration from an populated iteration, clone a selected populated iteration to all unpopulated iterations, create a “twin” of a selected populated iteration, create twins of a selected populated iterations for all unpopulated iterations, create an “offspring” of a selected populated iteration, create offsprings of a selected populated iterations for all unpopulated iterations, etc.

For example, an artist may select a populated iteration and using the iteration action menu to clone the populated iteration to an unpopulated iteration. The populated iteration may become a “master” iteration and the newly populated iteration may be a “clone” iteration. This type of relationship may be useful for quickly populating iterations that share very similar influence conditions where the artist does not feel the need to change the presentation of the Work under those Conditions. The clone is an exact match of its master. All of the event tracks and attributes in a clone iteration are the same as in the master iteration. The relationship may also allow the artist to make changes to the master that are automatically updated in the clones. In this example, the builder application may lock the features and assets of a clone to prevent any changes. All changes to the clone therefore may be required to be made in the master iteration.

In another example, an artist may select a populated iteration and using the iteration action menu to create a twin iteration in an unpopulated iteration. In this example, the populated source iteration may be referred to as a “dominant twin” whereas the newly-populated iteration may be referred to as a “Recessive Twin”. A twin relationship may be useful for creating iterations with matching event track arrangements but distinct audio mix differences. A recessive twin may contain all the same event tracks and attributes as its dominant twin at the time the recessing twin is created. In this example however, the media attributes of the assets, the assets, and the global attributes of the iteration are locked for changes by the artist. Again, in the locked condition, any changes to these features must be made in the dominant twin and may be automatically updated in the recessive twin. However, the track attributes in the recessive twin may be unlocked and adjustable by the artist. Changes to the track attributes may have no effect on the track attributes of the dominant twin, and vice-versa.

In yet another example, an artist may select a populated iteration and using the iteration action menu to create an offspring iteration in an unpopulated iteration. In this example, the populated source iteration may be referred to as a “parent” and the newly populated iteration may be referred to as an “offspring.” An offspring relationship may be useful for creating iterations with similar asset content, but with differences in the tracks and the attributes. The offspring iteration may contain all of the same assets and attributes as its parent at the time the offspring is created. After an offspring's creation, the assets in the offspring may remain in a linked relationship with the parent iteration. All of the attributes, including media, track, and global may be unlinked and freely adjustable. This may allow the artist to move the assets on the timeline and create new Clips in addition to adjusting attributes such as Volume and Panning. The relationship may also allow certain changes made to the assets contained in an offspring's Parent (such as the removal or replacement of an asset, or the addition of an asset on a new event track) to be reflected in the offspring. Changes to the attributes in the parent may have no effect on the offspring, and changes to the attributes in an offspring will have no effect on the parent. The artist may also freely add new assets (for example, on new event tracks) to the offspring, which may have no effect on the Parent.

The parent and child relationship may be extended multiple times, allowing for the creation of multiple generations. For example, an artist may generate grandchildren, great-grandchildren, etc.

In some examples, the builder application may also include a relationship category for iterations that are not linked to other iterations. These relationships may be referred to as unique. Thus, no other Iteration exerts any control upon the assets, event tracks, or attributes of a unique iteration. These unique iterations may generated by selecting or generating the tracks individually as described above, or by simply using the iteration action menu to create a copy of another populated iteration in an unpopulated iteration. For copies, there is no further relationship between the selected populated iteration and the copied previously unpopulated iteration. At the time that the copy is created, all of the assets, tracks, and attributes in the copy iteration maybe the same as in the source iteration. Thereafter the Iterations may be completely unlinked. The copied iteration may then be referred to as unique.

The builder application may also include relationship rules for the various relationships. For example, an iteration may be permitted to be both an offspring or twin of one iteration and a parent or twin to another. In another example, a clone may be prevented from being a parent, twin, or master to another Iteration. Any iteration other than a clone may be cloned.

The number of iterations required for an adaptive artistry work is directly related to the number of influences that the artist has selected for the project as well as the number of conditions associated with those influences. Each of these iterations must be populated in order to complete a work. By using an already populated iteration to populate another iteration, the builder application may assist the artist to quickly populate the unpopulated iterations without requiring the artist to prepare each iteration one at a time.

The iteration matrix may also track the relationships between the iterations. For example, turning to FIG. 5C, the iteration matrix 520 may be associated with a key 522. The key may be used to identify the various relationships among the iterations of the matrix. For example, iteration i07 is identified as a master iteration by the “m” designation. Iteration i08 is shown as a clone iteration by the “c” designation. As Iteration i08 is a clone of i07, the matrix may also identify which iteration is the master to this clone, thus, i08 includes a “c i07” designation. In this example, the matrix also identifies parent and child relationships (such as i15 and i16), twin relationships (such as i17 and i18), and unique iterations (such as i06).

The artist may also populate iterations by using a base iteration function. The artist may use the base iteration function to copy a particular iteration to all or less than all of the unpopulated iterations of a work. This may be helpful to an artist where a particular work should play back in exactly the same form under a plurality of different conditions or if there are only a few sets of influence conditions under which the particular work should be presented in an alternate form. For example, as shown in FIG. 5A and in more detail in FIG. 5E, base iteration block 540 may enable the artist to define a single iteration and use this iteration as a base or default iteration for all of the unpopulated iterations of the matrix. Thus, the artist may populate the base iteration, for example by using one of the methods described above, and then select to enable a base iteration function.

Once all of the iterations in the matrix have been populated (manually or by using the base iteration function), the artist may provide any desired metadata pertaining to the entire work such as a title, credits, etc. Returning to the work management interface of FIG. 4, the artist may then select the influence mapping button 450. In response, the builder application may use the work manager module to create a conditional relationship file for the work that contains a lookup table linking each possible set of the work's influence conditions to the specific iteration and iteration file that the artist as assigned to those conditions. The work file for the adaptive artistry work is then complete and saved. The work manager module closes, the artist is returned to the project manager interface.

The artist may now add new works to the project, edit existing works, or, once all of the works for a project have been completed, the artist may define the relationships between the project's influences and the use of the works during play back and their sequencing. In order to do so, the builder application may call the playlist manager module.

The playlist manager module may load the playlist file and display a playlist manager interface. Among other uses, the playlist manager module may allow an artist to designate when a work will play, in what order, and may also prevent some works from playing under certain influence conditions. For example, before a project is packaged, a playlist sequence may be assigned to each possible set of influence conditions associated with the project.

The playlist manager interface may include a playlist matrix to assist the artist in this task. Like the iteration matrix, the playlist matrix may include an interactive graphical display that provides the artist with a helpful visualization of the playlist sequences, relationships to other playlist sequences, and the relationship to the project's influences. Initially, the playlist sequences of the playlist matrix may be unpopulated, or may not include information identifying whether or when a work of the project may play as described above. The playlist matrix may also use a combination of color coding, text labeling, and other visual indicators to illustrate and clarify a playlist's status and any relationship to other playlists.

The playlists may add a further level of adaptivity to a project. Some Artists may want to fully utilize this additional flexibility, and some Artists may want to minimize (or even eliminate) the variability in the selection and sequence of works that are presented to an end-user (while keeping full adaptability in the works themselves). To accommodate such preferences, the playlist manager module may allow the artist to set “playlist influences” to specify which (if any) of a project's influences will be used to determine the playlist sequence that is presented to the end-user. In this example, when one or more of a project's influences are selected to have an effect on the playlists (for example, are active for a playlist), the conditions of those influences may be displayed in the playlist matrix so that the artist may specify or designate the playlist sequences under those conditions. If one or more of the project's influences are not selected to affect the playlists, those influences may not be displayed in the playlist matrix. If no influences are selected to affect the playlists, the artist may be required to program a base playlist that will be used as the playlist sequence for each time the project is played.

Similar to the process of populating iterations, an artist may populate the playlist sequences by selecting a pre-determined playlist in the matrix and establishing a relationship between it and one or more other selected playlists. The playlist relationships may include, for example, a clone relationship between playlist sequences where one playlist sequence being a “master” playlist sequence another being a “clone” playlist sequence. Similar to clone iterations described above, any change made to a master playlist sequence will be reflected in the Clone Playlist automatically.

The playlist relationships may include a parent and offspring relationship where one playlist sequence is a “parent” playlist sequence and another playlist sequence is an “offspring” playlist sequence. The order of the works in an offspring playlist sequence may be a linked copy of the parent playlist sequence where the artist may not be able to change the order of works in the offspring playlist sequence, but may insert or remove works within the offspring playlist sequence without changing the parent playlist sequence. Once a playlist sequence has been used as a parent, its content and sequence may be edited by the artist, and the results may also be reflected in the offspring. In some examples, any work added to a parent playlist sequence may be “bonded” to the work that precedes it in the playlist sequence. The bonding may be used to process two or more works as if they were one unit in the offspring playlist sequence. For example, if a new work is added to the parent playlist sequence following a work that has been removed from the offspring playlist sequence, the new work may not be added to the offspring playlist sequence.

The playlist sequence relationships may also be associated with additional rules. For example, a particular playlist sequence may be both an offspring of one playlist sequence and a parent of another playlist sequence. A clone may not be a master or parent of any other playlist sequences, but any playlist sequence other than a clone may be cloned.

The playlist sequences may also be populated using a base playlist sequence function. The artist may use the base playlist sequence function to copy a particular playlist sequence (or a base playlist sequence) to all or less than all of the unpopulated playlist sequences of a project. This function may be helpful where the artist wants the project to playback the same selection and sequence of works under all Conditions or where there are only a few sets of influence conditions under which the sequence of works in the Project should be presented in an alternate form.

If a work featured in a base playlist sequence has been restricted from playing under a specific condition (for example, by a playlist preference setting in the work manager interface), such works may be automatically checked for and skipped when writing data into any playlist sequence associated with a set of influence conditions that include the restricted condition. If the restricted condition is one of the active influence conditions during playback, the work may then be skipped during playback of the base playlist sequence.

The playlist manager interface may also include a playlist action menu. This menu may allow the artist to perform certain actions on a selected playlist sequence of the playlist matrix. For example, the menu may allow the artist to clear the selections or designations for a populated playlist sequence, copy a playlist sequence to or from another playlist sequence, copy to all unpopulated playlist sequences, clone to or from a selected playlist sequence, clone a playlist sequences to all unpopulated playlist sequences, clone a playlist sequences to all unpopulated playlist sequences, create offspring at a selected playlist sequence, and/or create offspring at all unpopulated playlists.

The builder application may perform some consistency checks. For example, the project manager module may checks the playlist file against the influence file to ensure that at least one work in the project will play under every possible set of influence conditions as noted above. If not, the project manager may notify the artist of the problem and details the conditions under which there is no work to be performed. The artist may then add a new work or edit an existing work.

Once the consistency checks have been completed and the works in the project have passed them, the artist may provide artwork assets to be displayed by the distribution application when the works of the project are played to the end user. The artwork selections are then saved in the artwork file for the project.

The artist may also provide any metadata for the completed project such as production credits, legal information, etc. The project metadata may be saved to the project file.

Once all of the project preparation steps have been completed, the artist may direct the project manager module to package the project. This packaging may compile, reformat or compress (if desired), and bundle all of the media assets together with the associated files for the project into an album file package. As noted above, the album file may be used for distribution and presentation via a distribution application. The album file may then be uploaded to a distribution server (such as server 110) to be distributed to client devices.

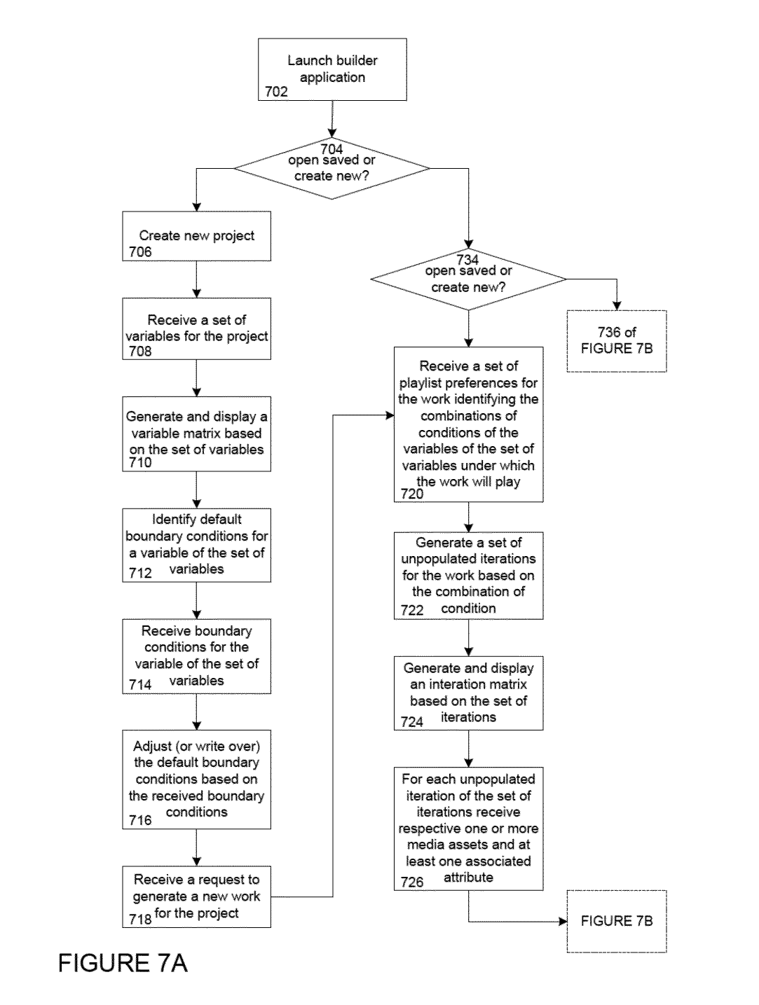

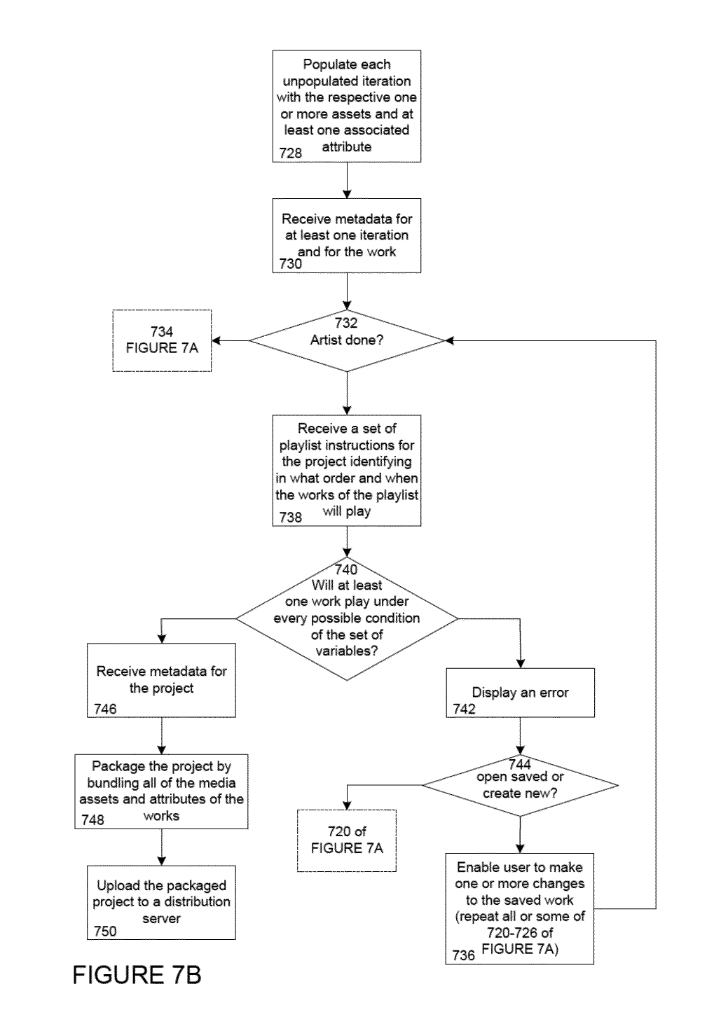

The flow diagram of FIGS. 7A and 7B is one example of the steps that may be performed by a processor of a first client device. For example, as shown in block 702, the client device launches a builder application. The artist may then instruct the processor as to whether it should create a new project or open a saved project at block 704.

If the artist has selected to create a new project, the builder application creates a new project, for example by creating and naming the various project files described above. The second client device may then receive a set of variables, or chosen influences, for the project from the artist at block 708. A variable matrix is then generated based on the set of variables and displayed to the artist at block 710. The processor then identifies default boundary conditions for a variable of the set of variables at block 712. The processor receives boundary conditions for the variable at block 714. The received boundary conditions are used to adjust the default boundary conditions, for example by rewriting over the default boundary conditions or creating new boundary conditions at block 716. Although the flow diagram depicts the adjustment of boundary conditions for a single variable, these steps may be completed for none, all or only some of the variables.

The processor receives a request to generate a new work for the project at block 718. For example, the processor may create and name the various work files described above. At block 720, the processor receives a set of playlist preferences for the work identifying the combinations of the variables of the set of conditions under which the work will play. The processor then generates a set of unpopulated (or empty) iterations (or iterations files) for the work based on the condition sets at block 722. The processor also generates and displays an iteration matrix based on the set of unpopulated iterations at block 724. For each unpopulated iteration of the set of iterations, the processor receives respective one or more media assets and at least one associated attribute setting. Turning to FIG. 7B, the processor populates each unpopulated iteration with the respective one or more assets and at least one associated attribute at block 728. The processor also receives metadata from at least one iteration and for the work at block 730.

At block 732, if the artist has not completed the work, for example by populating each of the iterations and entering any metadata, the processor may determine whether to open a saved work or create another new work based on input from the artist at block 734 of FIG. 7A. If the artist has selected to create a new work, the process continues at block 720, where the processor receives a set of playlist preferences, etc. If the artist has selected to open a saved work, the process continues to block 736 of FIG. 7B. There, the processor enables the user to make one or more changes to the saved work, for example, by repeating all or some of the steps of blocks 720, 722, 724, and 726 of FIG. 7A.

Returning to block 732, when the artist has completed the works of the project, the processor receives a set of playlist instructions for the project at block 738. These playlist instructions identify when and in what order the works of the playlist will play.

At block 740, the processor performs a consistency check to determine whether at least one work of the project will play under every possible combination of conditions of the set of variables. If not, the processor may display an error at block 742. Then, at block 744, the processor determines whether to open a saved work and continue with block 736 or to create a new work at block 720 of FIG. 7A based on input from the user.

Returning to block 740, if the project passes the consistency check, the processor receives metadata for the project at block 746. The project is then packaged by bundling all of the media assets and attributes of the works at block 748. The packaged project is then uploaded to a distribution server for distribution to other client devices at block 750.

In order to play an adaptive artistry project to an end user, a distribution application may be loaded onto the end user's second client device. For example, the end user may download the distribution application from server 110. Once loaded on the end user's client device, the distribution application may display an artist provided welcome or home screen.

The distribution application may then allow the end user to select various system preferences. For example, the user may choose to allow or disallow interruptions from other applications, to allow background play back via multitasking, to clear an end user's saved data (such as preferences or favorites information), or to reset a current cache of influence data.

If enabled by the artist, the user may also select options to recreate a particular adaptation of the adaptive artistry project from an adaptation file, set the influence conditions manually, or automatically identify influence conditions. In the case of recreation, the user may simply access the adaptation library and select to recreate a particular adaptation. For example, as noted above, if the artist may provide an adaptation file which defines the conditions for a particular adaptation of the adaptive artistry project. Alternatively, the end user may have selected to save a particular adaptation based on influence conditions which occurred in the past, such as where the end user may have previously listened to the project, or may download adaptation files created by other users (described in more detail below). The artist may select to enable or disable this feature. If enabled, the user may select to save a particular adaptation in an adaptation file at any time or may only be able to save particular adaptations associated with particular influence conditions. Thus, in this example the influence conditions need not be evaluated.

The end user may also set the influences. This mode of playback may allow an end user to exert some (or total) control over the evaluation of influence conditions that will be used to construct the works of an adaptive artistry project. In this example, the distribution application may display artist provided data input artwork and a request that the end user provide the desired condition values for some or all of the influences required by the project. The display may include a list of the influences for the project as well as the possible conditions for each influence of the list. For each influence of the list that is not a “Provided” influence, the end user may have a choice between allowing the influence condition to be assessed automatically (described in more detail below) or to manually select the specific condition the end user would like to assign to the influence. The list of influences may also have a default value, such as automatically evaluating the conditions or selecting the conditions manually.

When the end user indicates that he or she is finished making selections and providing all required data, the distribution application may cache the provided data and evaluate the influence conditions for any remaining unevaluated influences that were set for automatic evaluation (if any).

As noted above, the influence conditions may also be evaluated automatically by the distribution application. For example, the distribution application may determine whether the project includes any influences with Remote sources. If so, the distribution application may determine if the second client device has a network connection, for example a cellular or Internet connection. If a connection is detected, the second client device may transmit a request to server 110 or 111 for the conditions of the influences with Remote sources.

The request may include various information necessary to determine the condition of the Remote influences. For example, in the examples of “Outdoor Temperature” and “Sky Condition” influences, server 110 or 111 may receive GPS coordinates for the location of the second client device or an IP address of the second client device in the request. The server may then use this information to lookup the current weather conditions at or near the location of the requesting second client device. For example, as described above, the server 110 may maintain various databases for quick look up of the condition data.

The condition data may then be transmitted to the second client device. For example, if the influence is the local “Temperature,” the server may transmit a temperature of 50 degrees Fahrenheit. The second client device may receive the condition data and identify the relevant conditions by comparing the data to the lookup table in the project's influence file. In another example, the server may determine the actual conditions from the condition data (for example, a condition of “Cool” for the “Temperature” influence) and then transmit the influence conditions back to the second client device. The evaluated conditions are then cached or stored in local memory of the second client device.

If the project includes influences with local sources, the distribution application examines any local sources. For example, the second client device may include various local sources such as temperature sensors, a microphone, a clock, etc. The distribution application may receive data from these sources, identify the relevant conditions by comparing the data to the lookup table in the project's influence file, and cache the condition values.

If the distribution application is unable to identify all of the Remote or Local source conditions for the project, for example, if no network connection is detected, the server 110 or 111 is unresponsive, or the local source is simply not available, the distribution application may display a message to the end user. This message may indicate that some of the required data was unavailable and request the end user to provide the missing conditions manually. The end user may then provide any missing conditions and the distribution application may cache the condition values.

If the project includes influences with Provided sources, the distribution application may display a message requesting this data. For example, if the project does not include any automatically evaluated influences, such as only Provided sources, a message explaining this may be presented to the user. In another example, if all other conditions have been evaluated, and only Provided sources remain to be determined, a message explaining this may be presented to the user. In either example, the end user may then be able to input any of the Provided conditions, and the distribution application may cache the condition values.

As noted above, if the adaptive artistry project is associated with one or more hybrid influences, the hybrid influences may be evaluated by first determining the condition of the two-state variable. The conditions of the hybrid influences may be supplied automatically or by the end user as described above.

Once each of the influences has been evaluated, a playlist of iterations may be compiled. For example, the distribution application may access the project's playlist file and identify the set and sequence of works, and the relevant iterations files for those works, associated with the currently cached influence conditions from the lookup table. The iterations files for the identified works may then be requested and received from the server 110 or may be accessed from local memory of the client device. The works and associated iteration files may then be queued and cached, for example by writing the set and sequence to a sequence table of an adaptation file.

Once the works have been queued, the distribution application may access each work's conditional relationship file. From the conditional relationship file, the distribution application identifies the specific iteration file or files to be used with the distribution application's media mixer module based on the currently cached influence conditions. A pointer to the location of the specific iteration file may also be recorded within the active adaptation file, for example into the sequence table cell associated with the particular work. This process may be repeated until all of the iteration files have been identified.

The adaptation file may then be referenced to identify the first work in the playlist sequence as well as the iteration file associated with that work. For each work of the playlist, the identified specific iteration file is queued for playback, loaded by the media mixer module, and played to the end user. This may be repeated until all the works of the playlist are played.

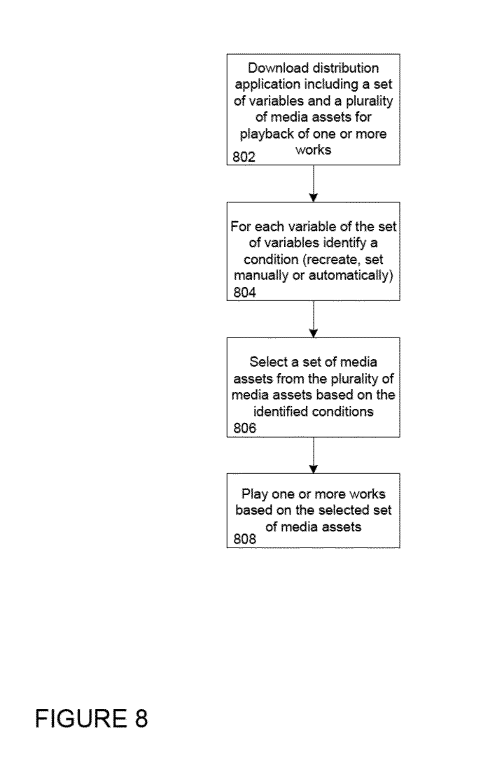

The flow diagram of FIG. 8 is one example of the steps that may be performed by a processor of a second client device. For example, the processor may download a distribution application at block 802. The distribution application includes, among other features, a set of variables as well as a plurality of media assets for playback of one or more works. At block 804, for each variable of the set of variables, the processor identifies a condition, for example by recreating, setting manually, or identifying automatically as described in detail above. The processor then selects a set of media assets from the plurality of media assets based on the identified conditions at block 806. The processor plays one or more works based on the selected set of media assets at block 808.

In some examples, a project may include an active adaptation feature. If enabled, the influences for the project may be re-evaluated while an iteration is being played. For example, at some time while a particular iteration is being played, such as half way through or within some time period before it has ended, the influences associated with Local or Remote sources may be re-evaluated. In this example, conditions which have been set by the end user may be tagged in the adaptation file as “set” while conditions that have been gathered through other methods may be tagged in the adaptation file as “gathered.” This may allow for the distinction between conditions that may be reevaluated without the assistance of the end user. For example, local time, weather, ambient lighting, etc., may all be tagged as “gathered” and therefore may be re-evaluated during playback of a work. In some examples, the “set” conditions may be reevaluated by requesting information from the end user or may not be reevaluated during the playback of a work to avoid requesting additional information from the end user.

If the reevaluations indicate that there have been any changes to any of the influence conditions, the adaptation file may be modified to record the changes. Any works of the playlist sequence that do not fit the changed conditions may be removed (or not queued). In this example, the iterations for each remaining work in the queue may be identified and written to the adaptation file based on the changes. However, new works need not be added to the queue and the sequence of the works may not be reordered. Once the current iteration has ended, the next iteration file in the queue may be played until all of the iterations have been completed. If, for example, the source for an influence condition or condition data is not available, the currently cached conditions may be used so as not to interrupt the playback of a project.

The end user may then replay the project under the currently cached influence conditions, update the influence conditions by re-evaluating the influences by using the evaluation process described above, or save the influence conditions or the playlist sequence and specific iterations files that were just performed to an adaptation file, if enabled by the artist. By saving the adaptation file to the library the end user may be able to replay the project as it was constructed under the same influence conditions at a later time. When the end user next views the welcome screen, the end user may access the adaptation library and replay the project directly from an adaptation file without reevaluating influence conditions.

In addition to saving an end user's or an artist's favorite or preferred iterations, the end user may also make playlists of iterations and generate personalized iterations. For example, the end user may save and manage personalized playlists for a project or projects. The end user may tag iterations during playback and organize the tagged iterations into a playlist. The playlist may be stored in an adaptation file for future playback or sharing.

In another example, an end user may generate personalized iterations. The distribution application may include a simplified a media mixer display (see FIG. 6A) that would provide the end user with the ability to manipulate event tracks (assets and attributes) of an iteration in much the same way the artist may when populating the iterations. The personalized iterations may be saved in a special iteration file for future playback or sharing.

The adaptive artistry system 100 may also provide end users with social interaction features to enable end users to share content and/or interact with one another. These social interactions may be facilitated and managed by the server 110 or 111. In one example, the distribution application may include a social networking module that allows end user to manage a profile, initial social interaction, with other end users, and interface with third-party social networks. These social interactions might be unidirectional, such as a broadcast to one or more other end users, or bidirectional, such as a conversation between two end users. Interactions may, for example, be between two individual end users of the same particular project, between groups of end users of the same particular project, or between a project's artist and some (or all) of the end users of a particular project.

The social interaction features may also include an option to share a particular adaptation of a work of a particular adaptive artistry project or a particular adaptation of an entire adaptive artistry project. For example, a sharing end user may save a favorite adaptation of a project to an adaptation file and share the adaptation file with another end user (such as a friend or group of friends). The distribution application may store the shared adaptation file at server 110 or 111. The server may then send a notification to the other end user about the availability of the shared adaptation file.

If the other end user is a registered or licensed user of the particular adaptive artistry project, the other end user may be notified of the shared adaptation file. A shared adaptation file may also include time-positioned comments and/or tags for display during playback so that the sharing end user may provide notes or comments to the other user. For example, the next time the other end user launches the distribution application for the project, the end user may receive the notification and may select to downloaded the shared adaptation file to the other end user's client device's distribution application. The other end user may then access the shared adaptation file from the adaptation library as described above.

If the other end user has not licensed the particular adaptive artistry project, the other end user may be given the option to temporarily download a customized adaptive album file (in some examples including a distribution application) with only the specific assets necessary to recreate the shared adaptation. In this example, the other end user may also be provided with an option to purchase and permanently download the complete project as well.

Alternatively, if the other end user has not licensed the particular adaptive artistry project, the other end user may be able to stream the shared adaptation from a website hosted by a server such as distribution server 110. The other end user may also receive an invitation to purchase, register, or license the project for the distribution application.

In addition to sharing particular adaptations, the social interaction features may allow an end user to share personalized playlists and iterations. Similar to sharing adaptations, the end user may send other users a personalized playlist of tagged iterations. This may be accomplished by uploading the playlist's adaptation file to a server, the server sending a notification to the other user, and the other user downloading the shared playlist's adaptation file to the other end user's client device. End users may also share the results of personalized iterations by sharing the special iteration file in a similar manner.

Other social interaction features may allow end users to establish and participate in synchronized performance sessions. For example, two or more end users with a license for the same adaptive artistry project may choose to synchronize the adaptive playback of the project. One end user's distribution application may be assigned as the “evaluator” while the other end users' distribution applications may be assigned as “spectators.” The evaluator distribution application may evaluate the influence conditions for the project and use the evaluated conditions to select or generate an adaptation file. The evaluation distribution application may then provide the adaptation file to all of the “spectator” distribution applications for synchronization. The timing and position of the playback among all of the distribution applications may be controlled by a server such as server 110 or 111.

This synchronized performance feature may also include a built-in chat mode (for example, via text, voice, and/or video) in order to allow the participants in the synchronized performance session to share information such as what the participants are seeing and/or hearing in real-time. These synchronized performance sessions may also be initiated or hosted by the artist or third-parties and allow the host to provide for real-time commentary about the adaptations being played.

Still other social interaction features may include “Remote” variables with social aspects. For example, the conditions values for these variables may be determined by the statements or behaviors of other individuals or groups who may or may not be users of a particular distribution application.

As these and other variations and combinations of the features discussed above can be utilized without departing from the subject matter defined by the claims, the foregoing description of the embodiments should be taken by way of illustration rather than by way of limitation of the subject matter defined by the claims. It will also be understood that the provision of the examples disclosed herein (as well as clauses phrased as “such as,” “including” and the like) should not be interpreted as limiting the claimed subject matter to the specific examples; rather, the examples are intended to illustrate only one of many possible embodiments. Further, the same reference numbers in different drawings may identify the same or similar elements.

1. A method of playing one or more works of an adaptive artistry project, the method comprising:
accessing a set of variables defining possible conditions under which one or more works of the adaptive artistry project will play;
accessing a plurality of media assets for playing the one or more works of the adaptive artistry project;
for each variable of the set of variables, identifying, by a processor of a client device, a current condition, wherein the current condition for a given one of the variables is identified by transmitting a request to a server computer and receiving condition data for the given one of the variables therefrom;
selecting a set of media assets from the plurality of media assets based on the identified condition associated with each respective variable; and
playing the one or more works of the adaptive artistry project based on the selected set of media assets.

2. The method of claim 1, further comprising:
accessing a set of playlist preferences for a given one of the one or more works of the adaptive artistry project, the set of playlist preferences identifying combinations of possible conditions of the set of variables under which the given work will play,
wherein selecting the set of media assets from the plurality of media assets is further based on the set of playlist preferences.

3. The method of claim 1, wherein the current condition for another given one of the variables is identified by requesting an end user to provide the at least one current condition, and the method further comprises receiving input, at a user input of the client device, identifying the at least one current condition.

4. The method of claim 1, wherein the current condition for another given one of the variables is identified based on information received from a sensor of the client device.

5. The method of claim 4, further comprising:
during the playing of the one or more works of the adaptive artistry project, determining a new current condition for the another given one of the variables based on information received from a sensor of the client device;
selecting a second set of media assets from the plurality of media assets based on the new current condition; and
playing an updated work of the adaptive artistry project based on the second set of media assets after the playing of the one or more works of the adaptive artistry project has completed.

6. The method of claim 1, wherein the current condition for another given one of the variables is identified from information stored in local memory of the client device identifying a set of conditions under which at least a portion of the one or more works of the adaptive artistry project were previously played by the client device.

7. The method of claim 1, wherein the one or more works of the adaptive artistry project include a first work and a second work, and the method further comprises:
accessing a set of playlist instructions for the adaptive artistry project, the playlist instructions identifying in what order the first work and the second work will play,
wherein playing the first work and the second work is based on the set of playlist instructions for the adaptive artistry project.

8. The method of claim 1, further comprising:
during the playing of the one or more works of the adaptive artistry project, determining a new current condition for the given one of the variables by transmitting a second request to the server computer and receiving updated condition data therefrom;
selecting a second set of media assets from the plurality of media assets based on the new current condition; and
playing an updated work of the adaptive artistry project based on the second set of media assets after the playing of the one or more works of the adaptive artistry project has completed.

9. The method of claim 1, further comprising determining the current condition for the given one of the variables by comparing the received condition data to a lookup table stored locally at the client device.

10. A system for playing one or more works of an adaptive artistry project, the system comprising:
memory storing a set of variables defining possible conditions under which one or more works of the adaptive artistry project will play, the memory also storing a plurality of media assets for playing the one or more works of the adaptive artistry project; and
a processor coupled to the memory, the processor being configured to:
for each variable of the set of variables, identify a current condition, wherein the current condition for a given one of the variables is identified by transmitting a request to a server computer and receiving the current condition for the given one of the variables therefrom;
select a set of media assets from the plurality of media assets based on the identified condition associated with each respective variable; and
play the one or more works of the adaptive artistry project based on the selected set of media assets.

11. The system of claim 10, wherein the processor is further configured to:
access a set of playlist preferences for a given one of the one or more works of the project, the set of playlist preferences identifying combinations of possible conditions of the set of variables under which the given work will play,
wherein selecting the set of media assets from the plurality of media assets is further based on the set of playlist preferences.

12. The system of claim 10, further comprising a user input device coupled to the processor and wherein the processor is further configured to:
identify the current condition for another given one of the variables by requesting an end user to provide the at least one current condition; and
receive input, at the user input of, identifying the at least one current condition.

13. The system of claim 10, further comprising a sensor device coupled to the processor and wherein the processor is further configured to identify the current condition for another given one of the variables based on information received from the sensor device.

14. The system of claim 10, wherein the memory further stores information identifying a set of conditions under which at least a portion of the one or more works of the adaptive artistry project were previously played by the client device, and wherein the processor is further configured to identify at least one of the current conditions from the stored information.

15. The system of claim 10, wherein the one or more works of the adaptive artistry project include a first work and a second work, wherein the memory further stores a set of playlist instructions for the adaptive artistry project, the playlist instructions identifying in what order the first work and the second work will play, and the processor is further configured to play the first work and the second work based on the set of playlist instructions for the adaptive artistry project.

16. The system of claim 10, wherein the processor is further configured to:
during the playing of the one or more works of the adaptive artistry project, update the current condition for the given one of the variables condition by transmitting a second request to a server computer and receiving an updated current condition;
select a second set of media assets from the plurality of media assets based on the updated current condition; and
play an updated work of the adaptive artistry project based on the second set of media assets after the playing of the one or more works of the adaptive artistry project has completed.

17. A tangible computer-readable storage medium storing (1) a set of variables defining possible conditions under which one or more works of the adaptive artistry project will play, (2) a plurality of media assets for playing the one or more works of the adaptive artistry project, and (3) computer readable instructions of a program, the instructions, when executed by a processor, cause the processor to perform a method, the method comprising:
for each variable of the set of variables, identifying, by a processor of a client device, a current condition, wherein the current condition for a given one of the variables is identified by transmitting a request to a server computer and receiving the current condition for the given one of the variables therefrom;
selecting a set of media assets from the plurality of media assets based on the identified condition associated with each respective variable; and
playing the one or more works of the adaptive artistry project based on the selected set of media assets.

18. The tangible computer-readable storage medium of claim 17, further storing a set of playlist preferences for a given one of the one or more works of the project, the set of playlist preferences identifying combinations of possible conditions of the set of variables under which the given work will play, and wherein the method further comprises selecting the set of media assets from the plurality of media assets is further based on the set of playlist preferences.

19. The tangible computer-readable storage medium of claim 18, wherein the one or more works of the adaptive artistry project include a first work and a second work, the medium further stores a set of playlist instructions for the adaptive artistry project, the playlist instructions identifying in what order the first work and the second work will play, and the method further includes playing the first work and the second work is based on the set of playlist instructions for the adaptive artistry project.
